(19) United States
(12) Patent Application Publication
(10) Pub. No.: US 2019/0289612 A1
(43) Pub. Date: Sep. 19, 2019

(54) WIRELESS COMMUNICATION VIA A LARGE BANDWIDTH CHANNEL

(71) Applicant: QUALCOMM Incorporated, San Diego, CA (US)

(72) Inventors: Jialing Li Chen, San Diego, CA (US); Lin Yang, San Diego, CA (US); Bin Tian, San Diego, CA (US); Sameer Vermani, San Diego, CA (US); Lochan Verma, San Diego, CA (US)

(21) Appl. No.: 16/354,086

(22) Filed: Mar. 14, 2019

Related U.S. Application Data
(60) Provisional application No. 62/644,239, filed on Mar. 16, 2018.

(51) Int. Cl. H04W 72/08; H04W 52/18

(52) U.S. Cl. CPC H04W 72/085; H04W 52/18

(57) ABSTRACT

This disclosure provides systems, methods, and apparatus, including computer programs encoded on computer-readable media, for communicating over a wireless communication network. A wireless communication device may be configured to generate and transmit a message according to a tone plan for transmission to multiple destination devices within one of a 240 or 320 MHz channel bandwidth. The message may include a short training field (STF) and a long training field (LTF). The STF may be used by a receiver to adjust an automatic gain control (AGC) function. The LTF may be used for channel estimation. In some implementations, the STF may have a data tone plan formed from a concatenated sequence of sub-STFs. A phase rotation applied to at least one of the sub-STFs of the concatenated sequence may reduce a peak-to-average-power ratio (PAPR) of the message as compared to a non- phase rotated concatenated sequence of sub-STFs.

### CROSS-REFERENCE TO RELATED APPLICATIONS

This Patent Application claims priority to U.S. Provisional Patent Application No. 62/644,239, filed Mar. 16, 2018, and entitled “SYSTEMS AND METHODS OF COMMUNICATING VIA SUB-BANDS IN WIRELESS COMMUNICATION NETWORKS,” and assigned to the assignee hereof. The disclosure of the prior Application is considered part of and is incorporated by reference in this Patent Application.

### TECHNICAL FIELD

Certain aspects of the present disclosure generally relate to wireless communication, and more particularly, to wireless communication via a large bandwidth channel (such as a 240 MHz or 320 MHz channel).

### DESCRIPTION OF THE RELATED TECHNOLOGY

In many telecommunication systems, communications networks can be used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching or routing technique used to interconnect the various network nodes and devices (for example, circuit switching or packet switching), the type of physical media employed for transmission (for example, wired or wireless), and the set of communication protocols used (for example, Internet protocol suite, SONET (Synchronous Optical Networking), Ethernet, or other communication protocols).

Wireless networks may be used when the network elements can be mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, or other frequency bands. Wireless networks may facilitate user mobility and rapid field deployment when compared to fixed wired networks.

The devices in a wireless network can transmit or receive information between each other. Device transmissions can interfere with each other, and certain transmissions can selectively block other transmissions. Where many devices can be a communication network, congestion and inefficient link usage can result.

### SUMMARY

Various implementations of systems, methods and devices within the scope of the appended claims each have several aspects, no single one of which can be solely responsible for the desirable attributes described herein. Without limiting the scope of the appended claims, some prominent features can be described herein.

One innovative aspect of the subject matter described in this disclosure can be implemented in an apparatus for wireless communication. The apparatus may include a processing system and an interface. The processing system may be configured to generate a message for transmission via a wireless network using a first channel having one of a 240 MHz or 320 MHz total channel bandwidth and generate a long training field (LTF) for the message. The LTF may include a training sequence based, at least in part, on the 240 MHz or 320 MHz total channel bandwidth for the first channel. The interface may be configured to output the message for transmission via the wireless network.

In some implementations, the LTF may be formed from a concatenated sequence of sub-LTFs that are defined for smaller bandwidth channels than the 240 or 320 MHz total channel bandwidth.

In some implementations, the processing system may be configured to apply a phase rotation to at least one of the sub-LTFs of the concatenated sequence.

In some implementations, the processing system may be configured to prepare the LTF by upclocking a sub-LTF defined for a smaller bandwidth channel.

In some implementations, the processing system may be configured to add sequence values for missing tones in a tone plan for the 240 MHz or 320 MHz total channel bandwidth, the missing tones remaining after upclocking the sub-LTF.

In some implementations, the processing system may be configured to apply a phase rotation to at least some of the sequence values.

In some implementations, the phase rotation may be configured to reduce a peak-to-average-power ratio (PAPR) of the message as compared to a non-phase rotated LTF.

In some implementations, the LTF may be formed from a concatenated sequence of sub-LTFs for an 80 MHz bandwidth channel.

In some implementations, the processing system may be configured to apply a phase rotation to at least some of the sub-LTFs.

Another innovative aspect of the subject matter described in this disclosure can be implemented as a method for wireless communication. The method may include generating a message for transmission via a wireless network using a first channel having one of a 240 MHz or 320 MHz total channel bandwidth. The method may include generating a long training field (LTF) for the message, wherein the LTF includes a training sequence based, at least in part, on the 240 MHz or 320 MHz total channel bandwidth for the first channel. The method may include outputting, via an interface, the message for transmission via the wireless network.

In some implementations, the LTF may be formed from a concatenated sequence of sub-LTFs that are defined for smaller bandwidth channels than the 240 or 320 MHz total channel bandwidth.

In some implementations, the method may include applying a phase rotation to at least one of the sub-LTFs of the concatenated sequence.

In some implementations, the method may include preparing the LTF by upclocking a sub-LTF defined for a smaller bandwidth channel.

In some implementations, the method may include adding sequence values for missing tones in a tone plan for the 240 MHz or 320 MHz total channel bandwidth, the missing tones remaining after upclocking the sub-LTF.

In some implementations, the method may include applying a phase rotation to at least some of the sequence values.

In some implementations, the phase rotation may be configured to reduce a peak-to-average-power ratio (PAPR) of the message as compared to a non-phase rotated LTF.

In some implementations, the LTF may be formed from a concatenated sequence of sub-LTFs for an 80 MHz bandwidth channel.

In some implementations, the method may include applying a phase rotation to at least some of the sub-LTFs.

Another innovative aspect of the subject matter described in this disclosure can be implemented in a wireless communication device. The wireless communication device may include a housing, an antenna attached to the housing and electrically coupled to a transceiver, the transceiver for communicating with a wireless network using a first channel having one of a 240 MHz or 320 MHz total channel bandwidth, and a processing system. The processing system may be configured to generate a message for transmission via the transceiver, generate a long training field (:TF) for the message, wherein the LTF includes a training sequence based, at least in part, on the 240 MHz or 320 MHz total channel bandwidth for the first channel, and output the message via the transceiver.

Details of one or more implementations of the subject matter described in this specification can be set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 shows an example 2N-tone plan.

FIG. 4 is an illustration of different modes available for a 240 or 320 MHz transmissions.

FIG. 5A shows example tone spacings and symbol durations at each of 80, 160, and 320 MHz transmissions.

FIG. 5B shows example index ranges for different fast Fourier transform (FFT) sizes at each of 80, 160, and 320 MHz transmissions.

FIG. 6A shows an example tone allocation for a 20 MHz transmission.

FIG. 6B shows an example tone allocation for a 40 MHz transmission.

FIG. 6C shows an example tone allocation for an 80 MHz transmission.

FIG. 7 shows an example of RU subcarrier indices.

FIG. 8A shows an example 4×240 MHz tone plan proposal using duplicates of 3 HE80 tone plans.

FIG. 8B shows an example 4×320 MHz tone plan proposal using duplicates of 2 HE160 or duplicates of 4 HE80 tone plans.

FIG. 9A shows a first example of RU subcarrier indices.

FIG. 9B shows a second example of RU subcarrier indices.

FIG. 9C shows a third example of RU subcarrier indices.

FIG. 10 shows an example breakdown of short training field (STF) tones in 26-tone RUs for an HE80 tone plan.

FIG. 11 shows an example breakdown of STF tones in 26-tone RUs for 80 MHz tone plan with 2× symbol duration.

FIG. 12 shows an example breakdown of STF tones in 26-tone RUs for 160 MHz tone plan with 2× symbol duration.

FIG. 13 shows example phase rotation coefficients for 240 MHz non-trigger based (TB) and TB STF sequences.

FIG. 14 shows example phase rotation coefficients for a 320 MHz non-TB STF sequence.

FIG. 15 shows example phase rotation coefficients for a 320 MHz TB STF sequence.

FIG. 16A shows an example tone plan for a 20 MHz channel.

FIG. 16B shows an example tone plan for a 40 MHz channel.

FIG. 16C shows an example tone plan for a 80 MHz channel.

FIG. 17A shows an example null subcarrier indices for 20, 40, and 80 MHz channels.

FIG. 17B shows an example pilot subcarrier indices for 20, 40, 80, and 160 MHz channels.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (TOT) network.

IEEE is preparing new bandwidth options for IEEE 802.11 which may use extreme high throughput (EHT) wireless communication. A large bandwidth channel in this disclosure refers to a wireless channel having a bandwidth of 240 MHz or larger. For example, IEEE 802.11be describes EHT wireless communication that may support large bandwidth channels having bandwidths of 240 MHz, 320 MHz, or larger. In some implementations, the total channel bandwidth may be comprised of a combination of subchannels (potentially having different sizes) in one or more frequency bands (such as the 5 GHz or 6 GHz frequency bands). The subchannels, which may be contiguous or non-contiguous in the frequency band, may be collectively referred to as a wireless channel.

Various implementations relate generally to a short training field (STF) and a long training field (LTF) that may be used for wireless communications transmitted over a 240 MHz or 320 MHz large bandwidth channel. Some implementations of this disclosure more specifically relate to a preamble that includes an STF and an LTF that may be sent before (or as a first part of) a message transmitted in a 240 MHz or 320 MHz channel. The tone plans for 240 MHz and 320 MHz channels may involve symbols having different symbol durations than those for smaller channels. For example, the tone plans may utilize symbols having durations two or four times longer than the symbol durations used for smaller channels. The STF sequences and LTF sequences may have 1×, 2×, or 4× symbol durations in various implementations.

The STF includes a training sequence that can be used by the receiving device to set or adjust an automatic gain control (AGC) function of the receiving device. AGC is a technique in an amplifier or chain of amplifiers used to adjust the signal amplitude at its output regardless of the variation of the signal amplitude at the input. The STF may include a training sequence of predetermined signals that can be used to identify the beginning of the transmission and to set the AGC. It also may be advantageous to reduce the peak-to-average-power ratio (PAPR) of the STF so that the STF does not skew the AGC incorrectly.

In some implementations, the STF may be formed from a concatenated sequence of sub-STFs that are defined for smaller bandwidth channels, such as 20 MHz, 40 MHz, 80 MHz or 160 MHz channels. For example, an STF for a 240 MHz channel may be formed using three instances of an STF (which may be referred to as a sub-STF) that is defined for an 80 MHz channel. In some implementations, a phase rotation may be applied to at least one of the sub-STFs of the concatenated sequence. One type of phase rotation is an inverse (such as 180 phase rotation). Phase rotation coefficients may be used to create 90, 180, or 270 degree phase rotations. A sign flip (changing polarity of one of the phase rotation coefficients) may be used to adjust a sub-STF or portion of an STF.

In some implementations, the STF may have phase rotations that are intended to minimize the PAPR. For example, the phase rotations may be applied to different sections of the STF (or sub-STFs) based on the PAPR for the full STF. In some implementations, the STF may depend on the tone plan for the large bandwidth channel. For example, a tone plan for a 240 MHz or 320 MHz may have particular resource units (RUs) defined for the total channel bandwidth. The STF may be adjusted based on the tone plan and based on the PAPR for the STF. In some implementations, the STF may accommodate puncturing of the channel. Puncturing refers to the omission of part of a channel. For example, some RUs or subchannels may be omitted from a transmission to avoid interference with other communication systems. The puncturing may be based on a subchannel or a portion (such as a 20 MHz portion) of the wireless channel. In some implementations, the STF may be punctured with minimal impact to the PAPR due to the type of training sequence used and the application of phase rotations.

As described above, a preamble typically includes an STF followed by an LTF at the beginning of a message prior to the payload. The LTF is generally used for channel estimation. Therefore, the LTF should have signals on all the tones for the channel. Some tones may carry pilot tones for alignment of the LTF. Other tones may include variable signals according to the LTF sequence. In some implementations, the LTF sequence may be based on a sub-LTF used for smaller bandwidth channels. Upscaling or duplication may be used to extend the sub-LTF to fill the larger bandwidth of an EHT 240 MHz or 320 MHz channel. Because the LTF is used for channel estimation, it may be desirable to add signals on some tones that do not have signals after upscaling the sub-LTF. For example, after upscaling (which also may be referred to as upclocking) the sub-LTF for a smaller bandwidth channel to form an LTF for the EHT channel, there may be some tones (referred to as missing tones) that do not have signals in the sequence. In some implementations, the sequence would be modified to fill those missing tones with signals so that all the tones can be included in the channel estimation. In some implementations, a phase rotation (or sign flip, or polarity change) may be applied to the signals on the missing tones so that those added signals can minimize the PAPR.

Particular implementations of the subject matter described in this disclosure can be implemented to realize one or more of the following potential advantages. In some implementations, the described techniques can be used to support EHT transmissions of 240 MHz bandwidth or beyond. Additionally, by reducing the PAPR of the STF, the receiver can perform AGC more accurately for the rest of the message. Advantageously, the STF and LTF for higher bandwidth channels may be based on training sequences defined for smaller bandwidth channels with phase rotations.

### Possible Alternatives

Various aspects of the novel systems, apparatuses, and methods can be described more fully hereinafter with reference to the accompanying drawings. The teachings of this disclosure can, however, be embodied in many different forms and should not be construed as limited to any specific structure or function presented throughout this disclosure. Rather, these aspects can be provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, an apparatus can be implemented, or a method can be practiced, using any number of the aspects set forth herein. In addition, the scope of this disclosure is intended to cover such an apparatus or method which is practiced using other structure, functionality, or structure and functionality in addition to or other than the various aspects of the disclosure herein. Any aspect disclosed herein can be embodied by one or more elements of a claim.

Although particular aspects can be described herein, many variations and permutations of these aspects fall within the scope of the disclosure. Although some benefits and advantages of some aspects are mentioned, the scope of the disclosure is not intended to be limited to particular benefits, uses, or objectives. Rather, aspects of the disclosure can be intended to be broadly applicable to different wireless technologies, system configurations, networks, and transmission protocols, some of which can be illustrated by way of example in the figures and in the following description of various aspects. The detailed description and drawings can be merely illustrative of the disclosure rather than limiting, the scope of the disclosure being defined by the appended claims and equivalents thereof.

### Implementing Devices

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), directsequence spread spectrum (DSSS) communications, a combination of OFDM and DSSS communications, or other schemes.

In some implementations, a WLAN includes various devices which can be the components that access the wireless network. For example, there can be two types of devices: access points (“APs”) and clients (also referred to as stations, or “STAs”). In general, an AP serves as a hub or base station for the WLAN and an STA serves as a user of the WLAN. For example, an STA can be a laptop computer, a personal digital assistant (PDA), a mobile phone, or the like. In an example, an STA connects to an AP via a Wi-Fi (for example, IEEE 802.11 protocol such as 802.11ax) compliant wireless link to obtain general connectivity to the Internet or to other wide area networks. In some implementations an STA also can be used as an AP.

The techniques described herein can be used for various broadband wireless communication systems, including communication systems that can be based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system can utilize sufficiently different directions to concurrently transmit data belonging to multiple user terminals. A TDMA system can allow multiple user terminals to share the same frequency channel by dividing the transmission signal into different time slots, each time slot being assigned to different user terminal. A TDMA system can implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers also can be called tones, bins, or other similar terms. With OFDM, each sub-carrier can be independently modulated with data. An OFDM system can implement IEEE 802.11 or some other standards known in the art. An SC-FDMA system can utilize interleaved FDMA (IFDMA) to transmit on sub-carriers that can be distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols can be sent in the frequency domain with OFDM and in the time domain with SC-FDMA. A SC-FDMA system can implement 3GPP-LTE (3rd Generation Partnership Project Long Term Evolution) or other standards.

The teachings herein can be incorporated into (for example, implemented within or performed by) a variety of wired or wireless apparatuses (for example, nodes). In some aspects, a wireless node implemented in accordance with the teachings herein may include an access point or an access terminal.

An access point (“AP”) can include, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) also can also include, be implemented as, or known as a user terminal, an access terminal (“AT”), a subscriber station, a subscriber unit, a mobile station, a remote station, a remote terminal, a user agent, a user device, user equipment, or some other terminology. In some implementations, an access terminal may be a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (for example, a cellular phone or smart phone), a computer (for example, a laptop), a portable communication device, a headset, a portable computing device (for example, a personal data assistant), an entertainment device (for example, a music or video device, or a satellite radio), a gaming device or system, a global positioning system device, or any other suitable device that is configured to communicate via a wireless medium.

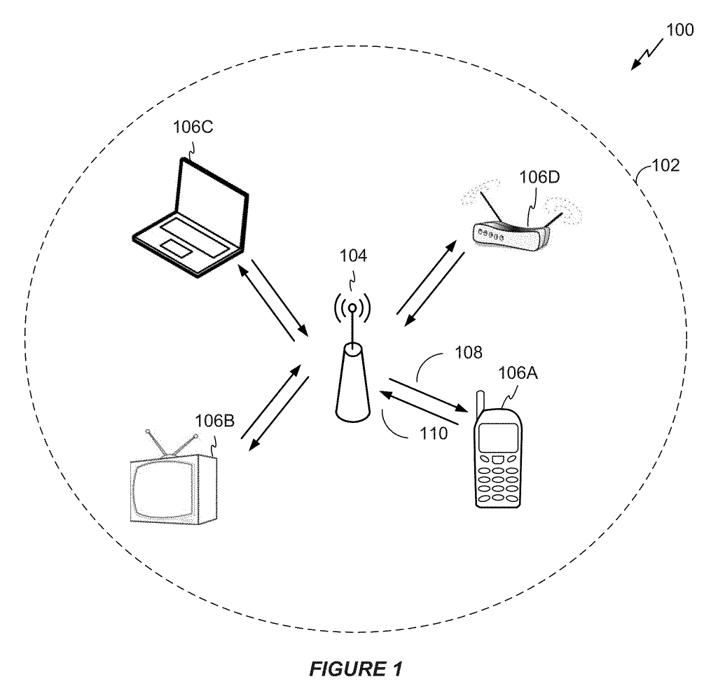

FIG. 1 illustrates an example of a wireless communication system 100 in which aspects of the present disclosure can be employed. The wireless communication system 100 can operate pursuant to a wireless standard, for example the 802.11ax standard. The wireless communication system 100 can include an AP 104, which communicates with STAs 106.

A variety of processes and methods can be used for transmissions in the wireless communication system 100 between the AP 104 and the STAs 106. For example, signals can be transmitted and received between the AP 104 and the STAs 106 in accordance with OFDM or OFDMA techniques. If this is the case, the wireless communication system 100 can be referred to as an OFDM or OFDMA system. Alternatively, signals can be transmitted and received between the AP 104 and the STAs 106 in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104 along with the STAs 106 associated with the AP 104 and that use the AP 104 for communication can be referred to as a basic service set (BSS). In some implementations, the wireless communication system 100 may not have a central AP 104, but rather may function as a peer-to-peer network between the STAs 106. Accordingly, the functions of the AP 104 described herein can alternatively be performed by one or more of the STAs 106.

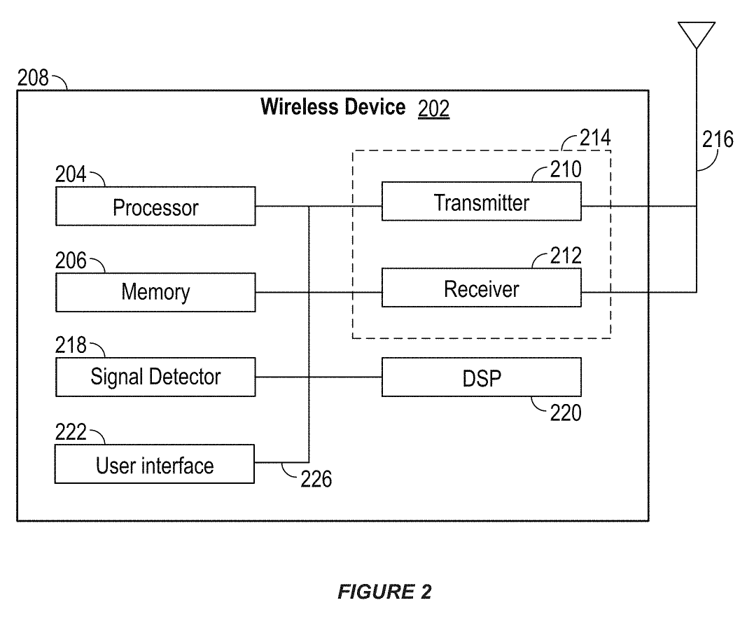

FIG. 2 illustrates various components that can be utilized in a wireless device 202 that can be employed within the wireless communication system 100. The wireless device 202 is an example of a device that can be configured to implement the various methods described herein. For example, the wireless device 202 can be the AP 104 or one of the STAs 106.

The wireless device 202 can include a processor 204 which controls operation of the wireless device 202. The processor 204 also can be referred to as a central processing unit (CPU). Memory 206, which can include both read-only memory (ROM) and random-access memory (RAM), provides instructions and data to the processor 204. A portion of the memory 206 also can include non-volatile random-access memory (NVRAM). The processor 204 may perform logical and arithmetic operations based on program instructions stored within the memory 206. The instructions in the memory 206 can be executable to implement the methods described herein.

The processor 204 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system also can include machine-readable media for storing software. Software shall be construed broadly to mean any type of instructions, whether referred to as software, firmware, middleware, microcode, hardware description language, or otherwise. Instructions can include code (for example, in source code format, binary code format, executable code format, or any other suitable format of code). The instructions, when executed by the one or more processors, cause the processing system to perform the various functions described herein. In some implementations, the processor 204, the processing system, the instructions, or any combination thereof, may control one or more components (for example, an interleaver or a segmenter) to generate a transmission according to a tone plan.

The wireless device 202 also can include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 also can include (not shown) multiple transmitters, multiple receivers, multiple transceivers, or multiple antennas, which can be utilized during MIMO communications, for example.

The wireless device 202 also can include a signal detector 218 that can be used to detect and quantify the level of signals received by the transceiver 214. The signal detector 218 can detect such signals as total energy, energy per subcarrier per symbol, power spectral density and other signals. The wireless device 202 also can include a digital signal processor (DSP) 220 for use in processing signals. The DSP 220 can be configured to generate a data unit for transmission. In some aspects, the data unit can be a physical layer data unit (PPDU). In some aspects, the PPDU is referred to as a packet.

The wireless device 202 can further include a user interface 222 in some aspects. The user interface 222 can include a keypad, a microphone, a speaker, a display, or other user interface components. The user interface 222 can include any element or component that conveys information to a user of the wireless device 202 or that receives input from the user.

The various components of the wireless device 202 can be coupled together by a bus system 226, or other interface. The bus system 226 can include a data bus, for example, as well as a power bus, a control signal bus, and a status signal bus in addition to the data bus. In some implementations, the components of the wireless device 202 can be coupled together or accept or provide inputs to each other using some other mechanism.

Although a number of separate components can be illustrated in FIG. 2, one or more of the components can be combined or implemented using other techniques. For example, the processor 204 can be used to implement not only the functionality described above with respect to the processor 204, but also to implement the functionality described above with respect to the signal detector 218 or the DSP 220. Further, each of the components illustrated in FIG. 2 can be implemented using a plurality of separate elements.

As discussed above, the wireless device 202 can include an AP 104 or an STA 106, and can be used to transmit or receive communications. The communications exchanged between devices in a wireless network can include data units which can include packets or frames. In some aspects, the data units can include data frames, control frames, or management frames. Data frames can be used for transmitting data from an AP or a STA to other APs or STAs. Control frames can be used together with data frames for performing various operations and for reliably delivering data (for example, acknowledging receipt of data, polling of APs, area-clearing operations, channel acquisition, carrier-sensing maintenance functions, or the like). Management frames can be used for various supervisory functions (for example, for joining and departing from wireless networks).

Certain aspects of the present disclosure support allowing APs 104 to allocate STAs 106 transmissions in optimized ways to improve efficiency. Both high efficiency wireless (HEW) stations, stations utilizing an 802.11 high efficiency protocol (such as 802.11ax), and stations using older or legacy 802.11 protocols (such as 802.11b), can compete or coordinate with each other in accessing a wireless medium. In some implementations, the high-efficiency 802.11 protocol described herein can allow for HEW and legacy stations to interoperate according to various OFDMA tone plans (which also can be referred to as tone maps). In some implementations, HEW stations can access the wireless medium in a more efficient manner, such as by using multiple access techniques in OFDMA. Accordingly, in the case of apartment buildings or densely-populated public spaces, APs or STAs that use the high-efficiency 802.11 protocol can experience reduced latency and increased network throughput even as the number of active wireless devices increases, thereby improving user experience.

In some implementations, APs 104 can transmit on a wireless medium according to various DL tone plans for HEW STAs. For example, with respect to FIG. 1, the STAs 106A-106D can be HEW STAs. In some implementations, the HEW STAs can communicate using a symbol duration four times that of a legacy STA. Accordingly, each symbol which is transmitted may be four times as long in duration. When using a longer symbol duration, each of the individual tones may use one-quarter as much bandwidth to be transmitted. For example, in various implementations, a lx symbol duration can be 3.2 μs, a 2× symbol duration can be 6.4 μs, and a 4× symbol duration can be 12.8 μs. The AP 104 can transmit messages to the HEW STAs 106A-106D according to one or more tone plans, based on a communication bandwidth. In some aspects, the AP 104 may be configured to transmit to multiple HEW STAs simultaneously, using OFDMA.

### Efficient Tone Plan Design for Multicarrier Allocation

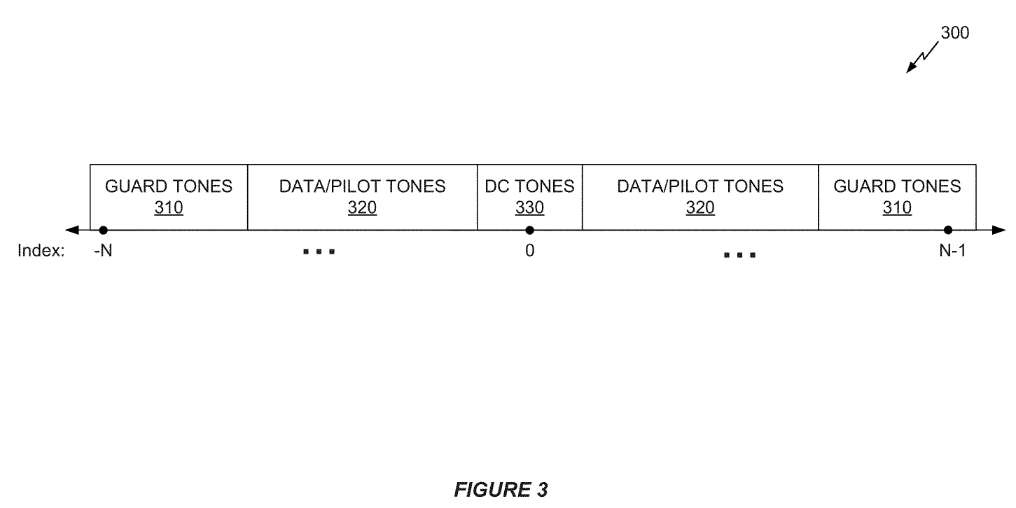

FIG. 3 shows an example 2N-tone plan 300. In some implementations, the tone plan 300 may correspond to OFDM tones, in the frequency domain, generated using a 2N-point fast Fourier transform (FFT). The tone plan 300 includes 2N OFDM tones indexed N to N-1. The tone plan 300 includes two sets of edge or guard tones 310, two sets of data/pilot tones 320, and a set of direct current (DC) tones 330. In some implementations, the edge or guard tones 310 and DC tones 330 can be null. In some implementations, the tone plan 300 may include another suitable number of pilot tones or may include pilot tones at other suitable tone locations.

In some aspects, OFDMA tone plans may be provided for transmission using a 4× symbol duration, as compared to various IEEE 802.11 protocols. For example, 4× symbol duration may use a number of symbols which can be each 12.8 μs in duration (different from symbols in certain other IEEE 802.11 protocols which may be 3.2 μs in duration).

In some aspects, OFDMA tone plans may be provided for transmission using a 2× symbol duration, as compared to various IEEE 802.11 protocols. For example, the 2× symbol duration may use a number of symbols which can be each 6.4 μs in duration (different from symbols in certain other IEEE 802.11 protocols which may be 3.2 μs or 12.8 μs in duration).

In some aspects, the data/pilot tones 320 of a transmission 200 may be divided among any number of different users. For example, the data/pilot tones 320 may be divided among between one and eight users. In order to divide the data/pilot tones 320, an AP 104 or another device may signal to the various devices, indicating which devices may transmit or receive on which tones (of the data/pilot tones 320) in a particular transmission. Accordingly, systems and methods for dividing the data/pilot tones 320 may be desired, and this division may be based upon a tone plan.

A tone plan may be chosen based on a number of different characteristics. For example, it may be beneficial to have a simple tone plan, which can be consistent across most or all bandwidths. For example, an OFDMA transmission may be transmitted over 20, 40, 80, 160, 240, or 320 MHz (or a combination thereof), and it may be desirable to use a tone plan that can be used for any of these bandwidths. Further, a tone plan may be simple in that it uses a smaller number of building block sizes. For example, a tone plan may contain a unit which may be referred to as resource unit (RU). This unit may be used to assign a particular amount of wireless resources (for example, bandwidth or particular tones) to a particular user. For example, one user may be assigned bandwidth as a number of RUs, and the data/pilot tones 320 of a transmission may be broken up into a number of RUs.

A tone plan also may be chosen based on efficiency. For example, transmissions of different bandwidths (for example, 20, 40, 80, 160, 240, or 320 MHz, or a combination thereof) may have different numbers of tones. Reducing the number of leftover tones may be beneficial. Further, it may be beneficial if a tone plan is configured to preserve 20, 40, 80, 160, 240, or 320 MHz boundaries in some implementations. For example, it may be desirable to have a tone plan which allows each 20, 40, 80, 160, 240, or 320 MHz portion to be decoded separately from each other, rather than having allocations which can be on the boundary between two different 20, 40, 80, 160, 240, or 320 MHz portions of the bandwidth. For example, it may be beneficial for interference patterns to be aligned with 20, 40, 80, 160, 240, or 320 MHz channels. Further, it may be beneficial to have channel bonding, which also may be known as preamble puncturing, such that when a 20 MHz transmission and a 40 MHz transmission can be transmitted, to create a 20 MHz “hole” in the transmission when transmitted over 80, 160, 240, or 320 MHz. This may allow, for example, a legacy packet to be transmitted in this unused portion of the bandwidth. This puncturing may apply to any transmission (for example, 20, 40, 80, 160, 240, or 320 MHz transmissions) and may create “holes” of at least 20 MHz in the transmission regardless of the channel or bandwidth being used. Finally, it also may be advantageous to use a tone plan which provides for fixed pilot tone locations in various transmissions, such as in different bandwidths.

As data transmission rate demands increase with additional devices joining networks or additional data being added for transmission over networks, larger channel bandwidths may be introduced, for example for orthogonal frequency-division multiple access (OFDMA) transmissions. In one example, tone plans for a 320 MHz total channel bandwidth may be introduced to assist in increasing peak system transmission data rates and to more efficiently utilize available channels. For example, as new frequencies are available for use (for example, 6 GHz), these new tone plans for the larger total channel bandwidths may more efficiently utilize the newly available channels. Moreover, an increased total bandwidth which may be provided by these new tone plans may allow for better rate vs range tradeoff. In this case, the same or a similar transmission rate may be used to provide larger coverage if a larger total bandwidth is used. Additionally, the larger total channel bandwidths also may increase tone plan efficiency (for example, for a particular BW, how many tones could be used for data transmission) and also may increase a number of guard bands. As with any total channel bandwidth being used, different modes may be available depending on channel availability. For example, current 80 MHz channel bandwidths may be separated into 20 MHz, 40 MHz, or 80 MHz modes.

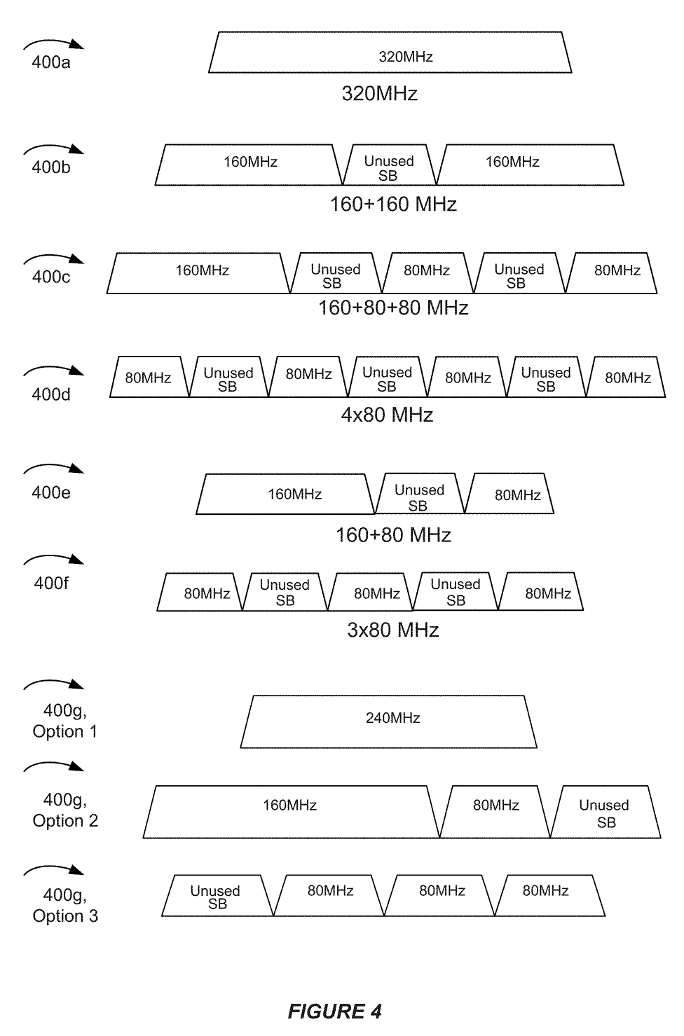

FIG. 4 is an illustration of different modes 400a-400g available for a 240 or 320 MHz transmission. As shown in FIG. 4, the 240 or 320 MHz transmissions may be transmitted in at least nine different modes as shown in 400a-400g. Each of the modes 400a-400g may represent a different combination of channel bandwidth (BW) and frequency bands that may be used, depending on channel availability (for example, in 2.4, 5, or 6 GHz networks). In a first mode 400a, the 320 MHz transmission may be transmitted in a single, contiguous 320 MHz frequency band. In a second mode 400b, the 320 MHz transmission may be transmitted in two disjoint 160 MHz frequency bands, where each of the disjoint 160 MHz frequency bands are contiguous frequency bands. As shown, each of the frequency bands is separated by unused sub-bands (SBs). In this context, unused SBs refer to portions of the frequency band that are not part of the wireless channel. In a third mode 400c, the 320 MHz transmission may be transmitted in three disjoint frequency bands, where one of the disjoint frequency bands is a 160 MHz frequency contiguous frequency band and the other two disjoint frequency bands are 80 MHz frequency contiguous frequency bands. In this third mode 400c, while the 320 MHz transmission is shown with the 160 MHz frequency band first followed by the two 80 MHz frequency bands, this arrangement of 160 and 80 MHz frequency bands may be in any order. As shown, each of the frequency bands is separated by unused SBs. In a fourth mode 400d, the 320 MHz transmission may be transmitted in four disjoint frequency bands, where each of the disjoint frequency bands is an 80 MHz frequency contiguous frequency band. In a fifth mode 400e, a 240 MHz bandwidth may be a 160 MHz and an 80 MHz frequency band separated by an unused 80 MHz frequency band. In a sixth mode 400f, the 240 MHz bandwidth may be three 80 MHz frequency bands separated by unused 80 MHz frequency bands. In a seventh mode 400g, a 240 MHz transmission may be transmitted in a single, contiguous 240 MHz bandwidth. In a first option for the seventh mode 400g, the 240 MHz bandwidth may be a single, contiguous 240 MHz frequency band with a single unused 80 MHz frequency band either preceding or following the 240 MHz frequency band. In a second option for the seventh mode 400g, the 240 MHz bandwidth may be a single 160 MHz frequency band and a single 80 MHz frequency band that are adjacent to each other, thus forming the contiguous 240 MHz bandwidth. In some implementations, the 160 MHz frequency band will precede the 80 MHz frequency band or vice versa. The 160 MHz and 80 MHz frequency bands may be preceded or followed by an unused 80 MHz frequency band. In a third option for the seventh mode 400g, the 240 MHz bandwidth may be three consecutive 80 MHz frequency bands, thus forming a contiguous 240 MHz bandwidth. The 80 MHz frequency bands may be preceded or followed by an unused 80 MHz frequency band. For any of the modes described herein, the unused SBs that separate the contiguous frequency bands may be of any BW or of different BWs. In some implementations, tone plans may be designed and signal generation may be completed for contiguous frequency band of 80 MHz, 160 MHz, and 320 MHz bandwidth sizes. In some implementations, tone plans may be designed and signal generation may be completed for a contiguous frequency band of 240 MHz bandwidth size.

Thus, each of the modes 400a-400g may have one or more options for creating the 320 MHz transmission. The mode 400a may include (1) a first option of having a single 320 MHz tone plan; (2) a second option of duplicating two 160 MHz tone plans, one in each of two PHY 160 MHz subchannels and separated by an unused SB; and (3) a third option of duplicating four 80 MHz tone plan, one in each of four PHY 80 MHz subchannels separated by unused SBs. The mode 400b may include (1) a first option of using two 160 MHz tone plans, each in one PHY 160 MHz subchannel and (2) a second option of duplicating four 80 MHz tone plans, one in each of four PHY 80 MHz subchannels and separated by unused SBs. The mode 400c may include (1) a first option of having a single 160 MHz tone plan in one PHY 160 MHz subchannel and duplicating two 80 MHz tone plans in each of the remaining PHY 80 MHz subchannels and (2) a second option of duplicating four 80 MHz tone plan, one in each of four PHY 80 MHz subchannels separated by unused SBs. The mode 400d may include an option of duplicating four 80 MHz tone plans, one in each of four PHY 80 MHz subchannels separated by unused SBs. The mode 400e may include a first option of using a 160 MHz tone plan for the 160 MHz frequency band and an 80 MHz tone plan for the 80 MHz frequency band. The mode 400e may include a second option of using four duplicate 80 MHz tone plans, one in each of the 80 MHz frequency bands. The mode 400f may duplicate three 80 MHz tone plans, each in one of the 80 MHz frequency bands. The mode 400g may include (1) a first option of using a single 240 MHz tone plan for the 240 MHz frequency band, (2) a second option of using a 160 MHz tone plan and an 80 MHz tone plan preceded or followed by unused SBs, and (3) a third option of using three 80 MHz tone plans preceded or followed by unused SBs. In some implementations, options 2 and 3 for mode 400g may correspond to the tone plan proposals for modes 400e and 400f.

Based on these modes and options, different tone plans may be designed or generated for the 80, 160, 240, or 320 MHz BWs. Tone plan designs for 80 MHz, 160 MHz, and 320 MHz for 3 symbol duration options are the building blocks. In some implementations, tone plan designs for 240 MHz for 3 symbol duration options may be included in the building blocks. In some implementations, the different frequency bands may use different symbol durations. For example, for the second option of the 240 MHz frequency band, the 160 MHz frequency band may use a first symbol duration while the 80 MHz frequency band may use a second symbol duration different from the first symbol duration. In some implementations, the tone plans for the 240 MHz bandwidth can be generated or designed based on the building blocks (for example, the 80 and 160 MHz transmissions discussed herein).

The different modes described herein for the 240 or 320 MHz channel BW may be different options of symbol durations and tone spacings, depending on the mode being used.

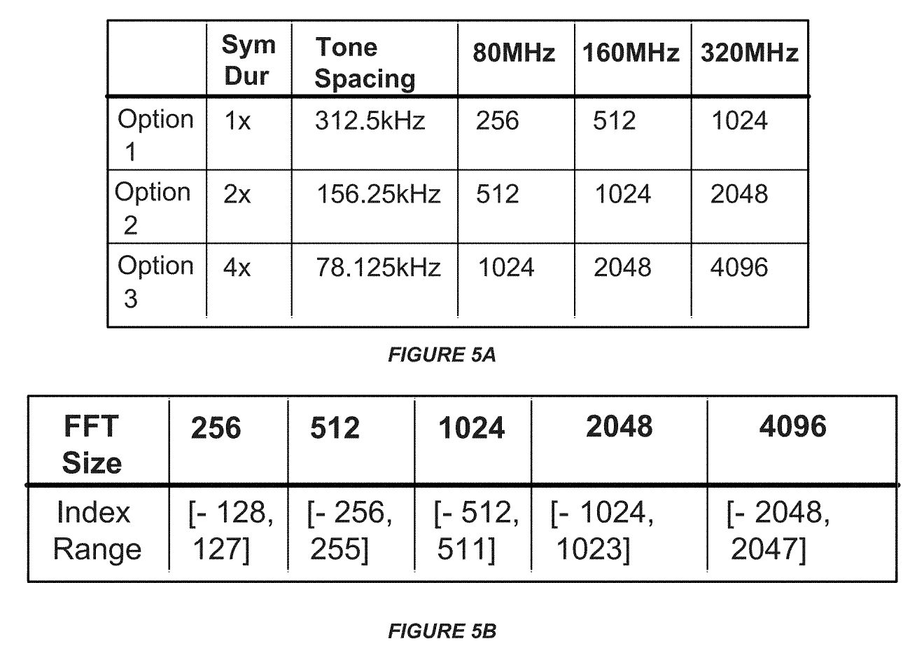

FIGS. 5A-5B show example tone spacings and index ranges for different FFT sizes and symbol durations at each of 80, 160, and 320 MHz transmissions. Various 802.11 protocols may use lx symbol durations (for example, 802.11a to 802.11ac). The lx symbol durations may have a tone spacing of 312.5 kHz. Other 802.11 protocols may use 4× symbol durations (for example, 802.11ax). The 4× symbol durations may have a tone spacing of 78.125 kHz. Next generation 802.11 devices and standards may utilize either the lx or 4× symbol durations or may introduce or utilize a 2× symbol duration of 6.4 μs having a tone spacing of 156.25 kHz. Specifically, FIG. 5A shows an FFT size for each option (for example, combination of symbol duration and tone spacing). For example, the 80 MHz channel BW has 256 tones available at lx symbol duration and 312.5 kHz spacing (option 1), 512 tones available at 2× symbol duration and 156.25 kHz spacing (option 2), and 1024 tones available at 4× symbol duration and 78.125 kHz spacing (option 3). The 160 MHz channel BW has 512 tones available at lx symbol duration and 312.5 kHz spacing, 1024 tones available at 2× symbol duration and 156.25 kHz spacing, and 2048 tones available at 4× symbol duration and 78.125 kHz spacing. The 320 MHz channel BW has 1024 tones available at lx symbol duration and 312.5 kHz spacing, 2048 tones available at 2× symbol duration and 156.25 kHz spacing, and 4096 tones available at 4× symbol duration and 78.125 kHz spacing. In some aspects, lx and 2× symbol durations may have similar benefits as compared to a 4× symbol durations. In some aspects, lx and 2× symbol durations may have lower complexity, latency, and memory requirements due to corresponding smaller FFT sizes as compared to the 4×symbol duration, which has a higher complexity, latency, and memory requirement due to its larger FFT size. The 1× and 2× symbol durations each have a lower tone plan and cyclic prefix (CP) or guard interval (GI) efficiency than the 4× symbol duration that has a higher tone plan and GI efficiency. Furthermore, the 1× and 2× symbol durations may not have outdoor support while the 4× symbol duration may have outdoor support, although the 320 MHz bandwidth may be generally used indoors. The 1× and 2× symbol durations may need a new design to provide OFDMA support, as they cannot be mixed with high efficiency STAs in DL/UL OFDMA. However, the 4× symbol duration may provide OFDMA support, as it can be mixed with HE STAs in DL/UL OFDMA. When memory size is not being considered, then the 4× symbol duration may be a more natural choice for symbol duration. However, if maintaining memory size is the goal, then the 1× or 2× symbol duration may be considered. For lx trigger based PPDU, the UL overhead of 50% in view of the 1.6 μs GI is too high, so the 2× symbol duration may be more likely a selection. In some implementations, reduced symbol durations may advantageously result in reduced complexity and reduced memory utilization.

Accordingly, the index ranges of the tones for each of these options is shown in FIG. 5B, which shows that 256 tones have a range of [−128, 127], 512 tones have a range of [−256, 255], 1024 tones have a range of [−512, 511], 2048 tones have a range of [−1024, 1023], and 4096 tones have a range from [−2048, 2047].

### Overview

The 80 MHz 4× symbol duration tone plan for disjoint 80 MHz channels may be based on 802.11ax 80 MHz single user and/or OFDMA tone plans. The 160 MHz 4× symbol duration tone plan for contiguous 160 MHz channels that are disjoint from other channels may use the 802.11ax single user or OFDMA 160 MHz tone plan.

The 320 MHz 4× symbol duration tone plan for contiguous 320 MHz channels may use two 160 MHz 4× symbol duration single user or OFDMA tone plans are duplicated in each 160 MHz subchannel of the 320 MHz channel. In this case, four 802.11ax 80 MHz 4× symbol duration single user or OFDMA tone plans are duplicated in each 80 MHz subchannel of the 320 MHz channel.

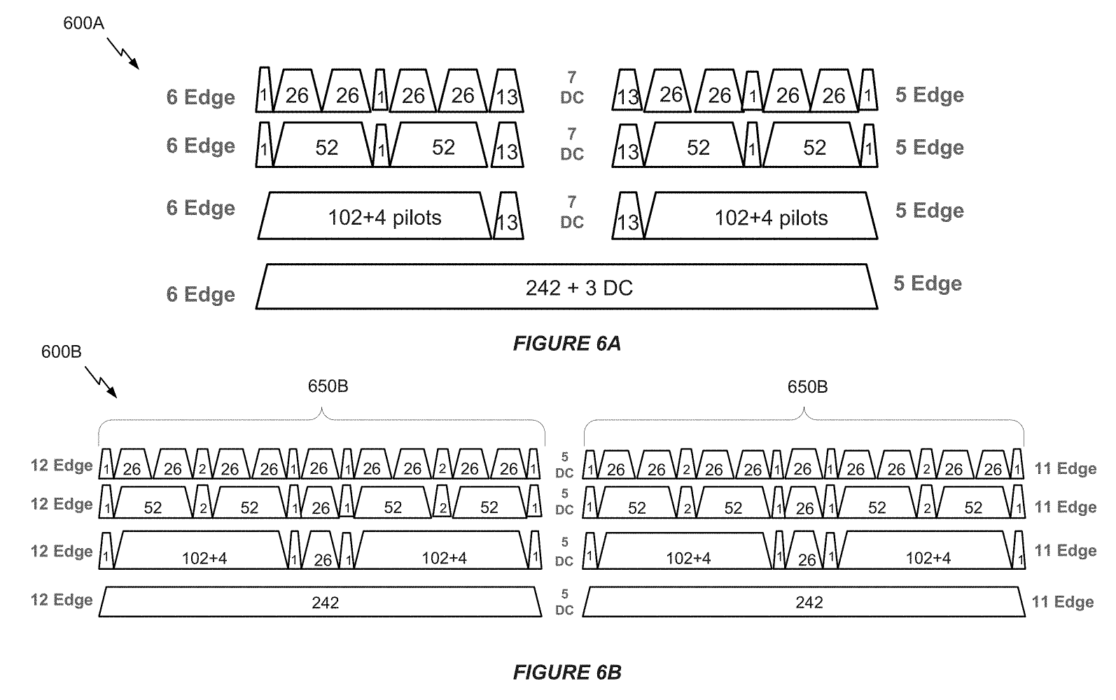

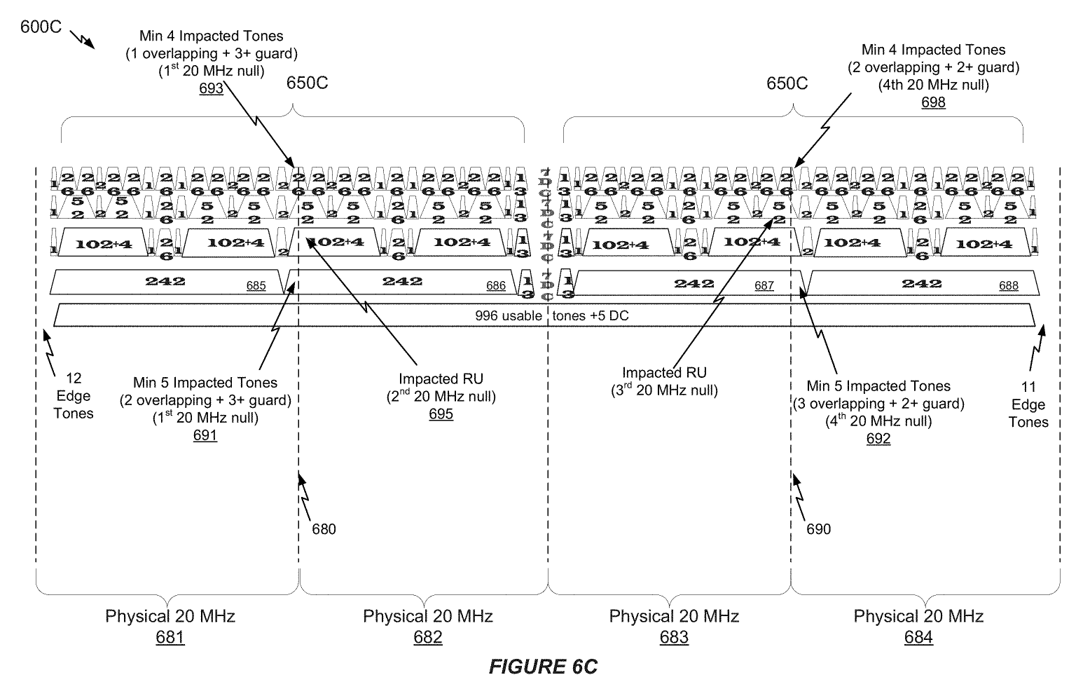

FIGS. 6A-6C show example 20 MHz, 40 MHz, and 80 MHz transmissions using 26-, 52-, 106-, 242-, 996- and other tone allocations.

### EXAMPLE IMPLEMENTATIONS

In particular, FIG. 6A shows example 20 MHz transmissions 600A, having 6 left edge tones, 7 DC tones, and 5 right edge tones, and a total of 238 usable tones for OFDMA or 242 usable tones for a single user. Although FIG. 6A shows four example transmissions 600A using various combinations of 26-, 52-, 106-, and 242-tone blocks, allocations within any given transmission can include multiple tone blocks of different sizes or different arrangements.

FIG. 6B shows example 40 MHz transmissions 600B, having 12 left edge tones, 5 DC tones, and 11 right edge tones, and a total of 484 usable tones. Although FIG. 6B shows four example transmissions 600B using various combinations of 26-, 52-, 106-, and 242-tone blocks, allocations within any given transmission can include multiple tone blocks of different sizes or having different arrangements. In FIG. 6B, each 40 MHz transmission 600B is a duplicate of two 20 MHz transmissions 650B. In some implementations, the two 20 MHz transmissions 650B may be similar to the 20 MHz transmissions 600A of FIG. 6A or any other 20 MHz transmission discussed herein.

FIG. 6C shows example 80 MHz transmissions 600C having 12 left edge tones, 7 DC tones, and 11 right edge tones, and a total of 994 usable tones for OFDMA, and a total of 996 usable tones for whole bandwidth (BW) allocation with reduced number of DC tones being 5. Although FIG. 6C shows five example transmissions 600C using various combinations of 26-, 52-, 106-, 242-, and 996tone blocks, allocations within any given transmission can include multiple tone blocks of different sizes or having different arrangements.

The fifth of the illustrated transmissions 600C includes a single-user tone plan having 5 DC tones in various configurations. Accordingly, the SU tone plan can include 996 usable tones.

In some implementations, larger BW transmissions (for example, 160 MHz, 240 MHz or 320 MHz) may be generated based on the 20, 40, or 80 MHz tone plans shown and described in relation to FIGS. 6A-6C. For example, the 40 MHz transmissions and the 80 MHz transmissions may be duplicated (for example, four times each) to create the 160 MHz and 320 MHz transmissions, respectively.

### Non-Contiguous and Fractional Bandwidth

As discussed above, the AP 104 can allocate one or more RUs to each STA 106A-106D. In some implementations, such allocations can be contiguous within the bandwidth of each transmission. In other implementations, the allocations can be non-contiguous. In some implementations, one or more unused SBs can be selected for, or determined to contain, interfering wireless transmissions. Such SBs can be referred to as null sub-bands and can contain one or more unallocated RUs.

Although various portions of a frequency band can be referred to herein as sub-bands, a person having ordinary skill in the art will appreciate, that in some implementations, sub-bands can be referred to as bands, channels, or subchannels. As used herein, “BSS BW” can refer to bandwidth setup for use in a particular BSS, for example an entire channel. “PPDU BW” can refer to bandwidth of a particular PPDU being transmitted. For example, the AP 104 (FIG. 1) can set up a BSS having 80 MHz BSS BW. Within the 80 MHz BSS BW, STAs 106A-106D can transmit on 20+40 MHz allocations due to interference in the null SB of the secondary channel. Thus, for FDMA packets, PPDU BW of a first packet can be 20 MHz, and PPDU BW of a second packet can be 40 MHz. For OFDMA packets, PPDU BW of a single packet can be 20+40 MHz. Although PPDU BW are discussed herein in terms of 20, 40, and 80 MHz allocations, a person of ordinary skill in the art would appreciate that the features described herein can be applied to BWs of other sizes or alignments.

### Determination of Impacted RUs

Fractional or non-contiguous channel allocation is available in a variety of BSS BWs including 80 MHz, 160 MHz, 80+80 MHz, 240 MHz, 160+80 MHz (or 80+160 MHz), 80+80+80 MHz (or 3×80 MHz), 320 MHz, 160+160 MHz (or 2×160 MHz), 160+80+80 MHz (or 160+2×80 MHz), or 80+80+80+80 MHz (or 4×80 MHz). The entire PPDU BW tone plan may not be suitable in the channel bonding cases discussed above. For example, null SBs may not be aligned to physical 20 MHz boundaries and RU boundaries in unmodified tone plans can result in insufficient inter-channel interference mitigation.

Referring back to FIG. 6C, a plurality of physical 20 MHz subchannels 681-684 and associated boundaries are shown. Although the illustrated transmission 600C is an 80 MHz transmission, the teachings herein also can be applied to 40 MHz transmissions, 160 MHz transmissions, 80+80 MHz transmissions (which, for example, can include two duplicated 80 MHz transmissions), 160+160 MHz transmissions, 320 MHz transmissions, 4×80 MHz transmissions (which, for example, can include two duplicated 160 MHz transmissions).

As shown in FIG. 6C, the first 242-tone block 685 is shifted 2 tones away from a boundary 680 of a first physical 20 MHz subchannel 681. The second 242-tone block 686 includes 2 tones crossing the 20 MHz boundary 680. Accordingly, in implementations where the first physical 20 MHz subchannel 681 is a null SB and 3 additional left guard tones are specified, the 2 overlapping tones, plus 3 left guard tones equals 5 total tones 691, which can be referred to as impacted tones. Such impacted tones can overlap with a null SB, or a guard band thereof. Similarly, because the second 242-tone block 686 includes impacted tones, it can be referred to as an impacted RU. Moreover, where the second 20 MHz subchannel 682 is a null SB, the entire second 242-tone block 686 can be impacted (240 overlapping tones, plus 2 right edge tones).

The 7 DC tones can be split into 3+4 tones across a 20 MHz boundary and can serve as guard bands to the 20 MHz boundary in some implementations. The third 242-tone block 687 includes 3 tones crossing a 20 MHz boundary 690, so assuming 2 right guard tones there are a total of 5 impacted tones 692 when the fourth physical 20 MHz subchannel 684 is a null SB. The fourth 242-tone block 688 is 3 tones away from the 20 MHz boundary 690. Although the foregoing description refers to the 242-tone blocks 685-689, the 26-, 56-, and 106-tone blocks can be impacted in the same way (and different tones of the same RU can be impacted with respect to different PHY 20 MHz subchannels). For example, the 106-tone block 695 (and others) can include at least 4 impacted tones 693 with respect to the first physical 20 MHz subchannel 681 and all tones can be impacted with respect to the second physical 20 MHz subchannel 682, and so forth. Moreover, in implementations where the number of guard tones is lower or higher, greater or fewer total tones can be impacted, respectively.

### Independent PPDUs for Non-Contiuous Channels

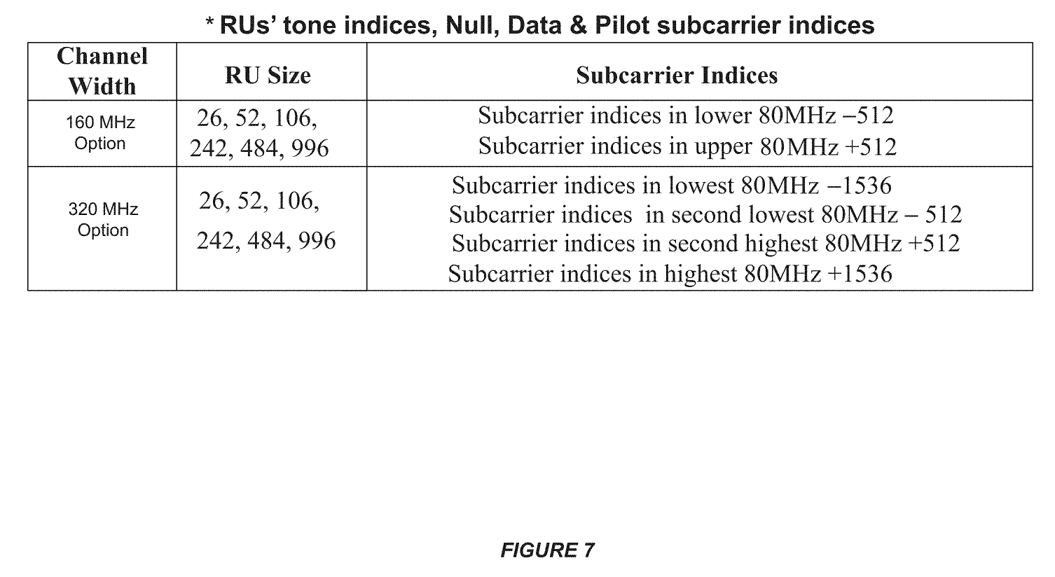

FIG. 7 shows an example of RU subcarrier indices. The RU subcarrier indices as shown in FIG. 7 may correspond to the 160 MHz and 320 MHz 4× symbol duration tone plans described herein (also labeled in reference to a 160 MHz Option and a 320 MHz Option). For example, the 160 MHz tone plan described in relation to the 160 MHz Option may have RU sizes of 26, 52, 106, 242, 484, and 996 tones. The subcarrier indices in the lower 80 MHz subchannel may be reduced by 512 while the subcarrier indices in the upper 80 MHz subchannel may be increased by 512. For example, the 80 MHz tone plan may use an index range of [−512,511] and may have 1024-point. The 160 MHz tone plan may duplicate two 80 MHz tone plans. Thus, the lower half of the 160 MHz tone play may use an index range of [−1024, −1], which comes from the 80 MHz tone plan index range minus 512 (for example, [−512, 511]−512)=[−1024, −1]. The upper half may use a range of [0,1024], which comes from the 80 MHz tone plan index range plus 512 (for example, [-512,511]+512=[0, 1023]. By referring to how the indices are related, the RU boundaries, null tones, or pilot tones, in 160 MHz, may be described based on or in reference to the 80 MHz.

The 320 MHz tone plan described in relation to the 320 MHz Option also may have RU sizes of 26, 52, 106, 242, 484, and 996 tones. The subcarrier indices in the lowest 80 MHz subchannel may be reduced by 1536 while the subcarrier indices in the second lowest 80 MHz subchannel are reduced by 512. The subcarrier indices in the second highest 80 MHz subchannel may be increased by 512, while the subcarrier indices of the highest 80 MHz subchannel may be increased by 1536.

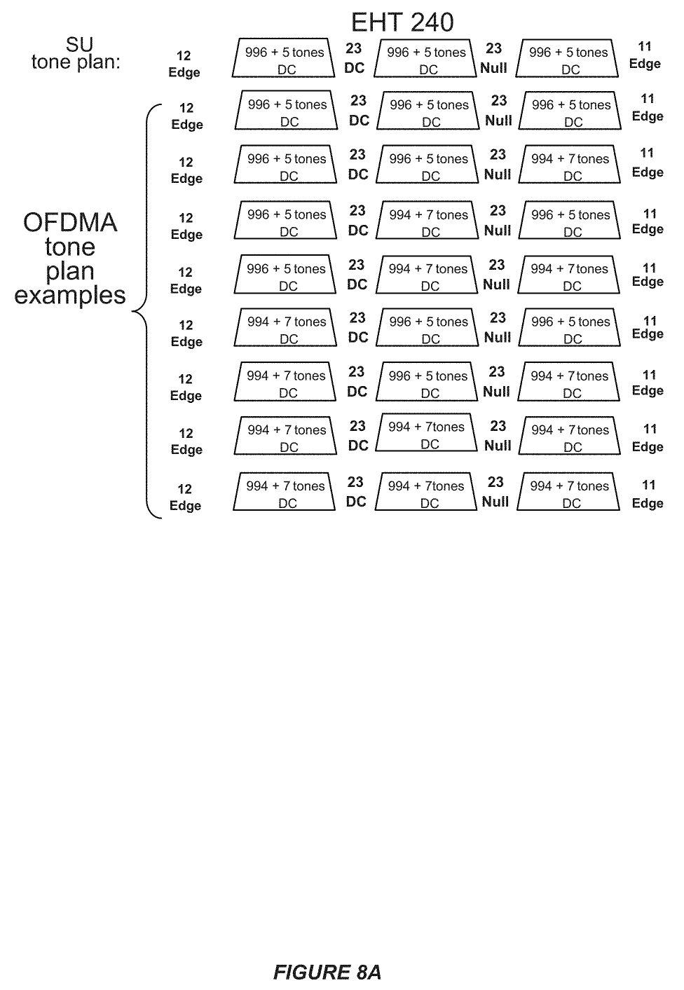

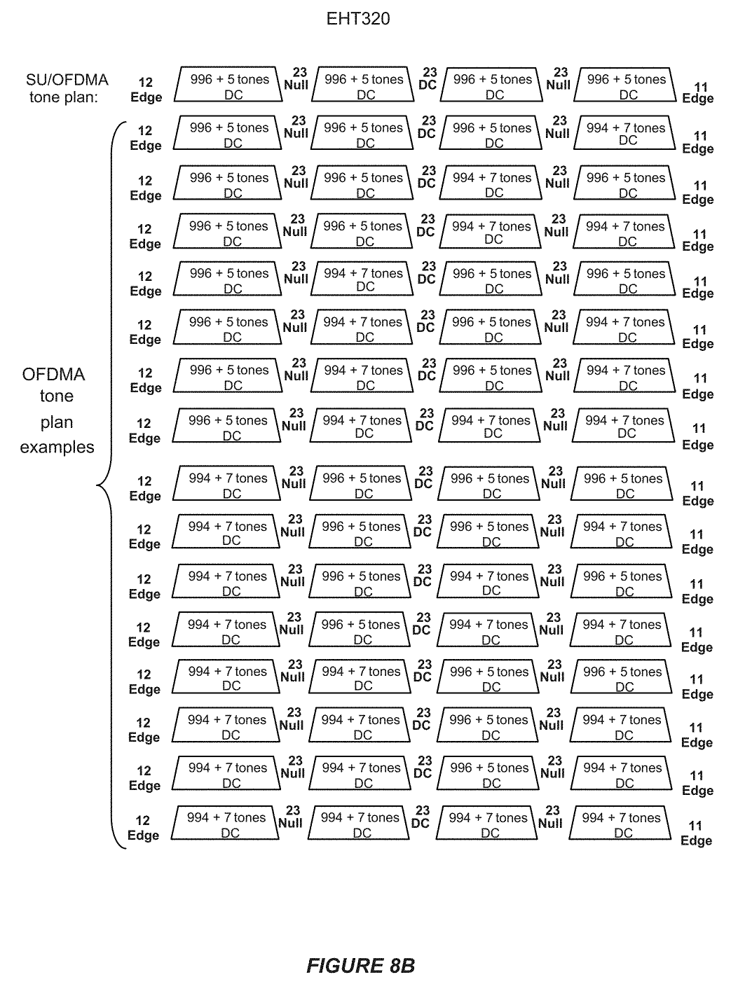

FIG. 8A shows an example 4×240 MHz tone plan proposal using duplicates of 3 HE80 tone plans.

FIG. 8B shows an example 4×320 MHz tone plan proposal using duplicates of 2 HE160 or duplicates of 4 HE80 tone plans.

In some aspects, the selected 4× tone plan may be selected independent of a hardware implementation and regardless of bandwidth mode (for example, 320 MHz compared to 4×80 MHz, or 160+80 MHz compared to 3×80 MHz).

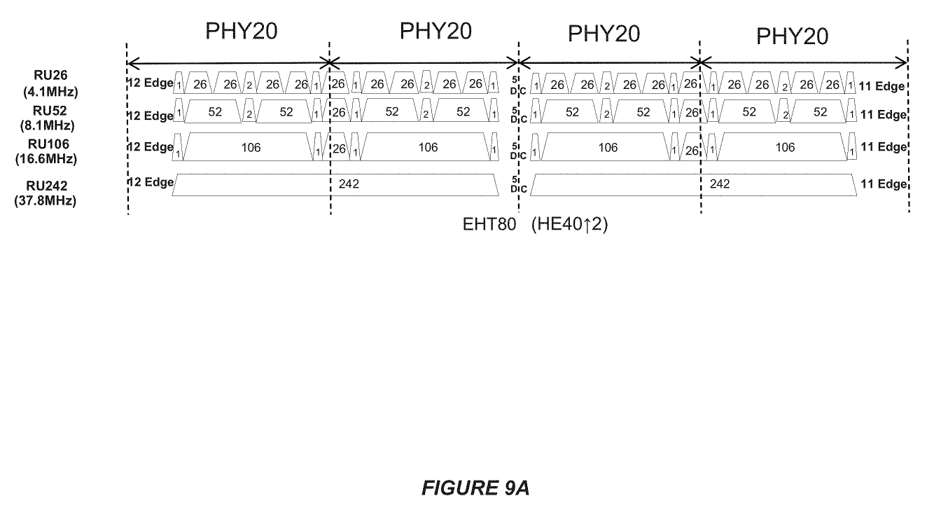

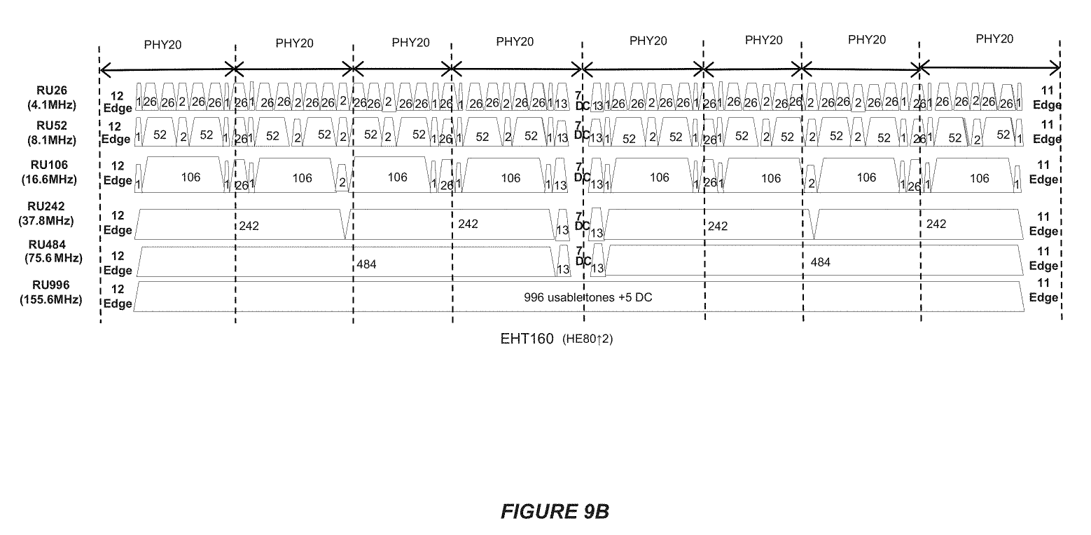

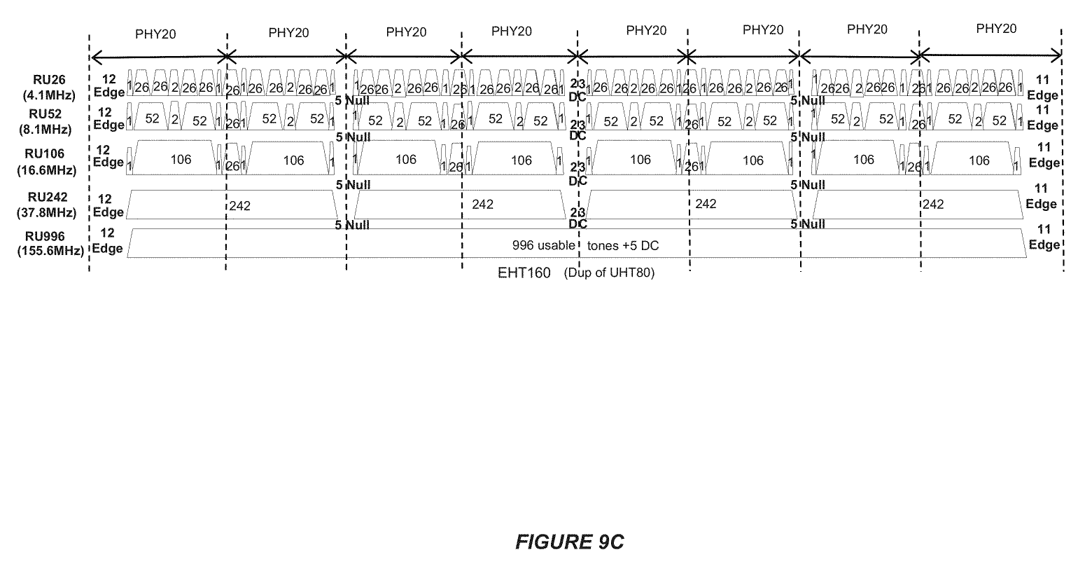

FIGS. 9A-9C show examples of RU subcarrier indices.

FIG. 9A shows 26-tone, 52-tone, 106-tone, and 242-tone RUs tone plans for an extreme high throughput (EHT) 80 (2× Option 1). The tone plan is formed by the HE40 SU or OFDMA tone plan upclocking by 2. The 26-tone RU tone plan has a granularity of ˜4.1 MHz. As shown, the 26-tone RUs are separated by various quantities of null tones (for example, 1 null tone or 2 null tones) with a 12 left+11 right guard tone configuration and a 5-tone DC. The 52-tone RU tone plan has a granularity of 8.1 MHz. As shown, the 52-tone RUs are separated by various amounts of null tones (for example, 1 or 2 null tones) with a 12 left+11 right guard tone configuration and a 5-tone DC. The 106-tone RU tone plan has a granularity of 16.6 MHz. As shown, the 106-tone RUs are separated by 1 null tone with a 12 left+11 right guard tone configuration and a 5-tone DC. The 1 null tone may separate the 106-tone RUs from the edge tones, from 26-tone RUs, and from the 5-tone DC. The 242-tone RU tone plan has a granularity of 37.8 MHz. As shown, the 242-tone RUs have a 12 left +11 right guard tone configuration and a 5-tone DC. In such aspects, the minimum frequency chunk for preamble puncturing for these tone plans is PHY 20 MHz. As noted herein, since the 5^{th} and 14^{th} 26-tone RUs cross the PHY 20 MHz boundary, these RUs may be disabled if preamble puncturing is used.

The EHT160 tone plan and the EHT320 tone plan may be based on the HE80 and RE160 tones plans, respectively, each upclocked by 2 (2× Option 2A). FIG. 9B shows 26-tone, 52-tone, 106-tone, 242-tone, 484-tone, and 996-tone RUs tone plans for the 2×EHT160/EHT320 by HE80/HE160 upclocking by 2 (2× Option 2A). The 26-tone RU tone plan has a granularity of 4.1 MHz. As shown, the 26-tone RUs are separated by 1 or 2 null tones with a 12 left+11 right guard tone configuration and a 7-tone DC with 13-tone RUs on either side of the 7-tone DC. The 52-tone RU tone plan has a granularity of 8.1 MHz. As shown, the 52-tone RUs are separated by 1 or 2 null tones with a 12 left+11 right guard tone configuration and a 7-tone DC with 13-tone RUs on either side of the 7-tone DC. The 106-tone RU tone plan has a granularity of 16.6 MHz. As shown, the 106-tone RUs are separated by 1 or 2 null tones with a 12 left +11 right guard tone configuration and a 7-tone DC with 13-tone RUs on either side of the 7-tone DC. The 242-tone RU tone plan has a granularity of 37.8 MHz. As shown, the 242-tone RUs has a 12 left+11 right guard tone configuration and a 7-tone DC with 13-tone RUs on either side of the 7-tone DC. As shown, the 484-tone RUs have a 12 left +11 right guard tone configuration and a 7-tone DC with 13-tone RUs on either side of the 7-tone DC with 13-tone RUs on either side of the 7-tone DC. As shown, the 996-tone RU is one single 996-tone RU with a 12 left+11 right guard tone configuration and no DC. No preamble puncturing (for example, alignment) may occur at PHY 20 MHz chunks because these tone plans are not preamble puncturing friendly. For example, with PHY 20 MHz chunks, various tones cross the 20 MHz boundaries, including the 5^{th} 26-tone RU, the 10^{th} 26-tone RU, the 5^{th} 52-tone RU, the 3^{rd} 106-tone RU, the 14^{th} 26-tone RU, the 24^{th} 26-tone RU, the 28^{th} 26-tone RU, the 12^{th} 52-tone RU, the 6^{th} 106-tone RU, and the 33^{rd} 26-tone RU. Each of these RUs may have different numbers of tones that cross the respective 20 MHz boundaries.

Alternatively, the EHT160 and EHT320 tone plans may be based on duplications of two and four EHT80 tone plans, respectively (2× Option 2B). FIG. 9C shows 26-tone, 52-tone, 106-tone, 242-tone, and 996-tone RUs tone plans for the 2×EHT160/EHT320 using duplications of 2 or 4 EHT80 tone plans, respectively (2× Option 2B). The 26-tone RU tone plan has a granularity of 4.1 MHz. As shown, the 26-tone RUs are separated by 1 or 2 null tones with a 12 left +11 right guard tone configuration and a 23-tone DC separating the 4^{th} and 5^{th} PHY20 blocks and 5 null tones separating the 2^{nd} and 3^{rd} PHY20 blocks and the 6^{th} and 7^{th} PHY20 blocks. The 52-tone RU tone plan has a granularity of 8.1 MHz. As shown, the 52-tone RUs are separated by 1 or 2 null tones with a 12 left +11 right guard tone configuration and a 23-tone DC separating the 4^{th} and 5^{th} PHY20 blocks and 5 null tones separating the 2^{nd} and 3^{rd} PHY20 blocks and the 6^{th} and 7^{th} PHY20 blocks. The 106-tone RU tone plan has a granularity of 16.6 MHz. As shown, the 106-tone RUs are separated by 26-tone RUs and 1 null tone with a 12 left+11 right guard tone configuration and a 23-tone DC separating the 4^{th} and 5^{th} PHY20 blocks and 5 null tones separating the 2^{nd} and 3^{rd} PHY20 blocks and the 6^{th} and 7^{th} PHY20 blocks. The 242-tone RU tone plan has a granularity of 37.8 MHz. As shown, the 242-tone RUs are separated by 5 null tones with a 12 left+11 right guard tone configuration and a 23-tone DC. As shown, the 996-tone RU is one single 996-tone RU with a 12 left+11 right guard tone configuration and no DC. PHY 20 MHz boundary alignment for preamble puncturing may be accomplished by disabling the 5^{th}, 14^{th}, 23^{rd}, and 32^{nd} 26-tone RUs with a slightly lowered efficiency as compared to 2× Option 2A.

In some implementations, involving EHT BWs and higher total BWs, short training field (STF) and long training field (LTF) sequence designs may be implemented that are specific to the EHT and the higher total BWs. Similarly, STF and LTF sequence designs that account for puncturing also may be implemented. For example, coefficients in STF sequences may be set to zero when values corresponding to tone indices in the STF sequences fall within RUs that have no users assigned to those RUs.

Puncturing may exist due to occupancy of certain channels or subchannels by neighboring BSSs, occupancy of certain channels or subchannels by incumbent technologies, or the like. In one or more bandwidth modes, the puncturing may make at least a portion of the BW unavailable for transmission or communication. In some implementations, the puncturing may be based on multiples of a predetermined BW, such as 20 MHz or based on RU size. In some implementations, when one or more subchannels or portions of the BW are punctured, the selected tone plan may be based on available (for example, not punctured) RUs.

### EHT Tone Plan Design

EHT tone plans may be similar to 4× symbol duration tone plans as discussed in further detail in FIGS. 6A-6B, 16A-16C, and 17A-17B. For 240 or 320 MHz channels, 2× or 4× symbol duration tone plans may be implemented. For example, the tone plans for the 240 or 320 MHz channels and signal generation may be completed for each contiguous subchannel having 80, 160, and 320 MHz sizes. Such tone plans for the 240 or the 320 MHz channels may implement a 4× symbol duration tone plan for 80 and 160 MHz subchannels based on HE80 and HE160 tone plans, respectively. The 240 and 320 MHz channels may use duplicates of 3 or 4 HE80 tone plans, respectively. For example, FIGS. 8A and 8B show some example tone plans for 240 and 320 MHz channels that are made up of HE80 tone plans. Tone plans for 80 MHz channels in 2× symbol duration tone plans may use HE40 tone plans that are upclocked by 2. The 160 and 320 MHz channels in the 2× symbol duration tone plans may either use HE80 and HE160 tone plans upclocked by 2, respectively, or duplicate 2 and 4 EHT 80 MHz channel tone plans, respectively. The 240 MHz channel in 2× symbol duration tone plans may use [HE40 HE80] upclocked by 2 (when the 240 MHz channel is treated as 80+160 MHz) or [HE80 HE40] upclocked by 2 (when the 240 MHz channel is treated as 160+80 MHz) or [HE40 HE40 HE40] upclocked by 2 (when the 240 MHz channel is treated as 3×80 MHz). For examples, see FIGS. 9A-9C.

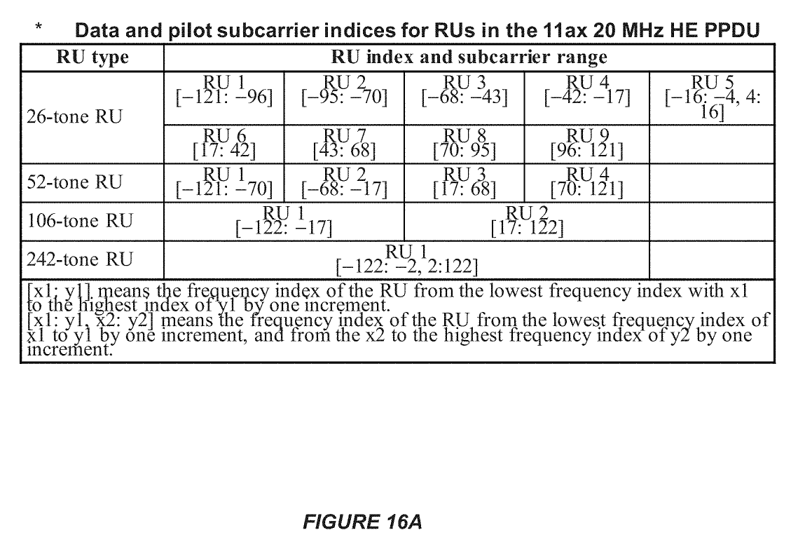

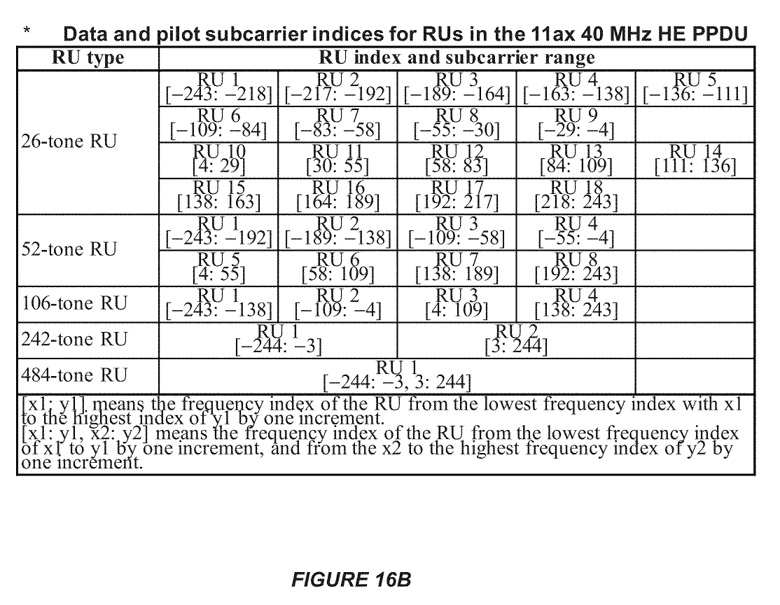

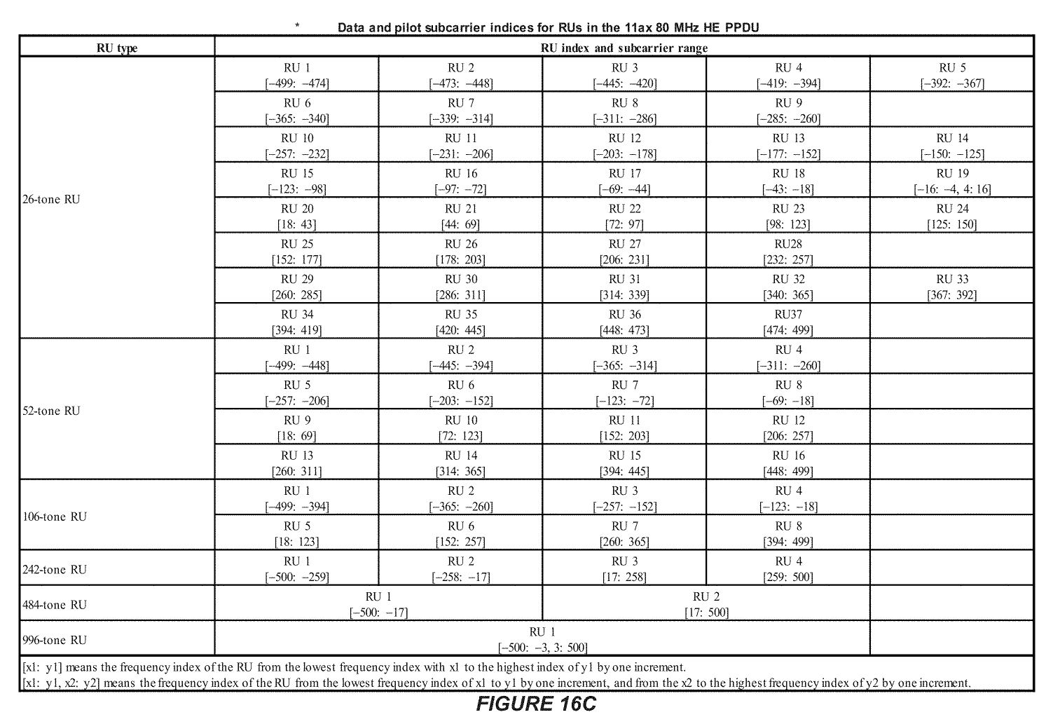

The tone plan for 240 MHz and 320 MHz channels may be based on a replication or expansion of the tone plans for smaller subchannels. FIG. 16A shows an example tone plan for a 20 MHz channel. FIG. 16B shows an example tone plan for a 40 MHz channel. FIG. 16C shows an example tone plan for a 80 MHz channel. In some implementations, the tone plans for 20 MHz, 40 MHz, or 60 MHz may be expanded to fill 240 MHz or 320 MHz bandwidth.

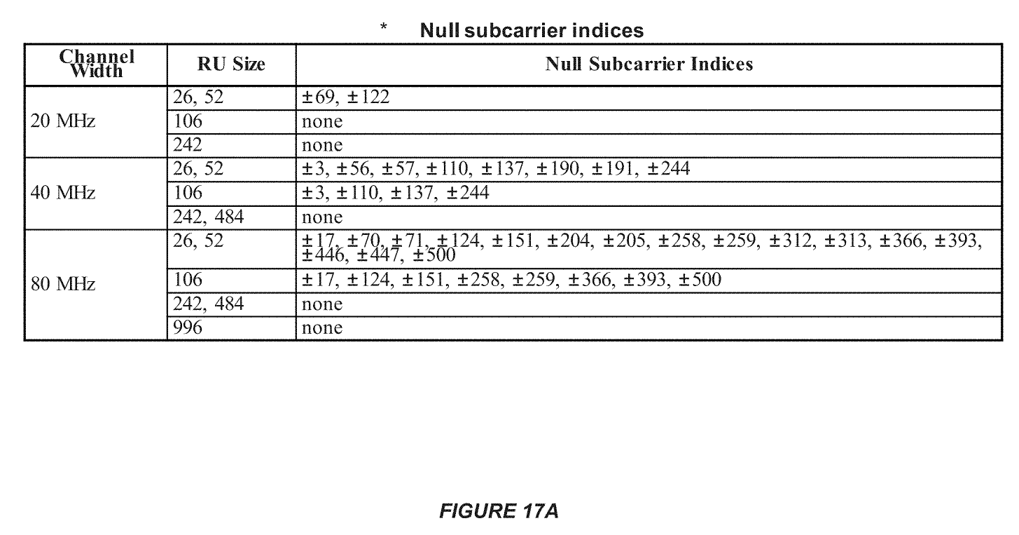

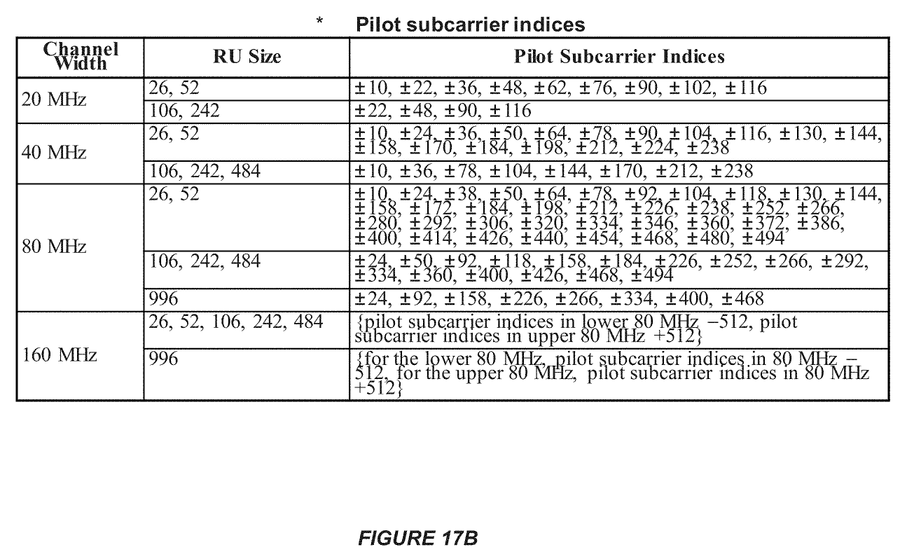

The tone plan may also define null subcarriers and pilot subcarriers. In some implementations, the null subcarriers and pilot subcarriers may be based on smaller subchannels. FIG. 17A shows an example null subcarrier indices for 20, 40, and 80 MHz channels. FIG. 17B shows an example pilot subcarrier indices for 20, 40, 80, and 160 MHz channels.

### EHT Short Training Field (STF) Sequences Design

The EHT STF sequences for 2× symbol duration tone plans may be designed as described herein and may apply to all bandwidth modes (for example, may apply to the total BWs described herein and any additional BWs not explicitly discussed herein). However, for total BWs of 240 or 320 MHz, the STF sequence design may be a concatenated STF sequence and phase rotation design.

### EHT STF Tones Design With 2× Tone Plans

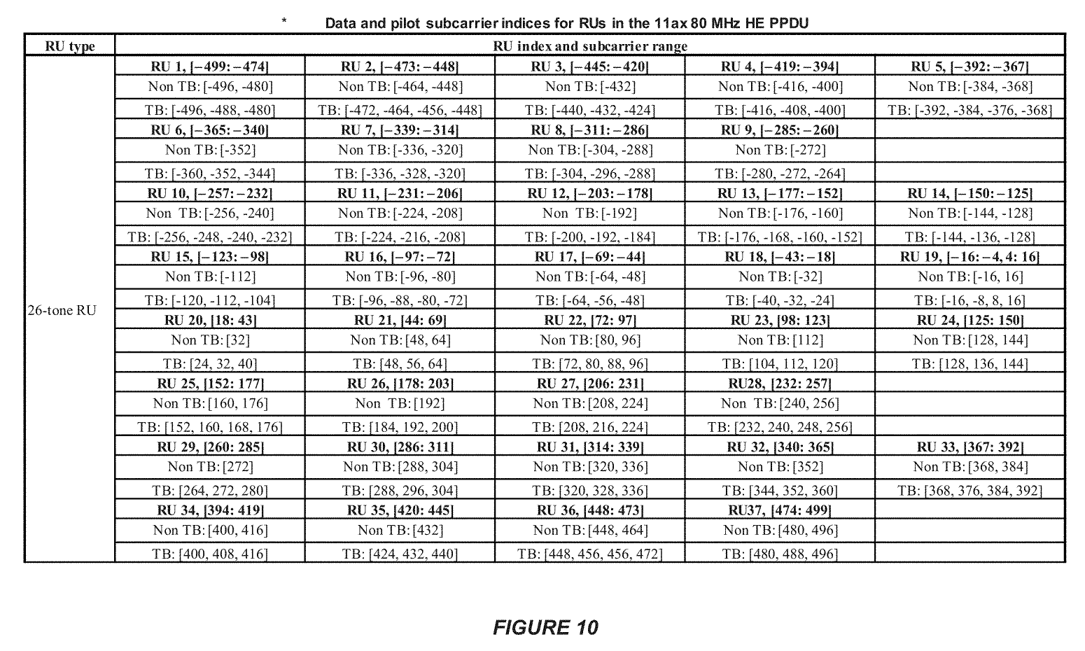

The STF tone plan for 2× symbol duration may be designed such that each 26-tone RU has 3-4 STF tones in a non-trigger based (non-TB) EHT-STF and 6-7 STF tones in a trigger based (TB) EHT-STF in 4× symbol duration numerology. Further details are provided in FIGS. 10-12.

In EHT 80 and 160 MHz channels that are based on 2× symbol duration tone plans, since each data tone plan is based on HE40 and HE80 tone plans upclocked by 2, each 26-tone RU spans a wider range of tones (for example, 26×2−1=51 tones in a 4× symbol duration tone plan). Thus, non-TB EHT STFs and TB EHT-STFs provide appropriate coverage of tones in the 2× symbol duration tone plans as compared to the 4× symbol duration tone plans. Thus, EHT 80 and 160 MHz channels may use same STF tone designs for HE-STFs in corresponding BWs. The EHT 320 MHz channel may use the same STF tone designs for 80 MHz HE-STFs in each of the 80 MHz subchannels for the EHT 320 MHz channel.

FIG. 10 shows an example breakdown of short training field (STF) tones in 26-tone RUs for an HE80 tone plan. The breakdown indicates a mapping, in 4× symbol duration numerology, of STF tones in each 26-tone RU in 11 ax HE80, where 1-2 STF tones for the non-TB HE-STFs and 3-4 STF tones for the TB HE-STF are used. The HE160 tone plan may be similar.

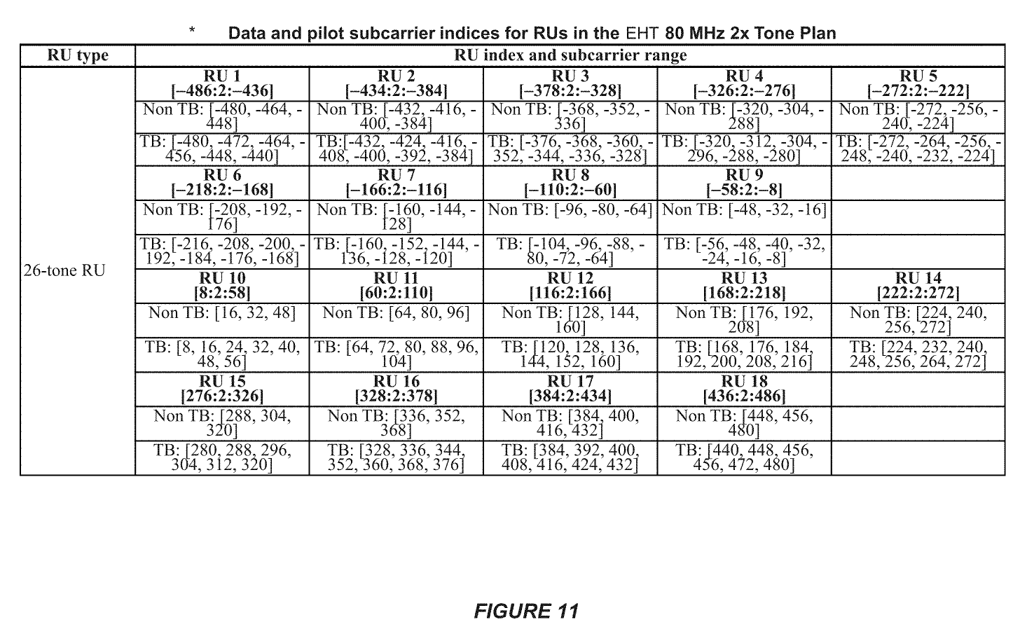

FIG. 11 shows an example breakdown of STF tones in 26-tone RUs for 80 MHz tone plan with 2× symbol duration. The breakdown indicates a mapping, in 4× symbol duration numerology, of STF tones in each 26-tone RU in EHT 80 MHz tone plan in 2× symbol duration, where 3-4 STF tones are used for the non-TB EHT-STFs and 6-7 STF tones for the TB EHT-STF are used.

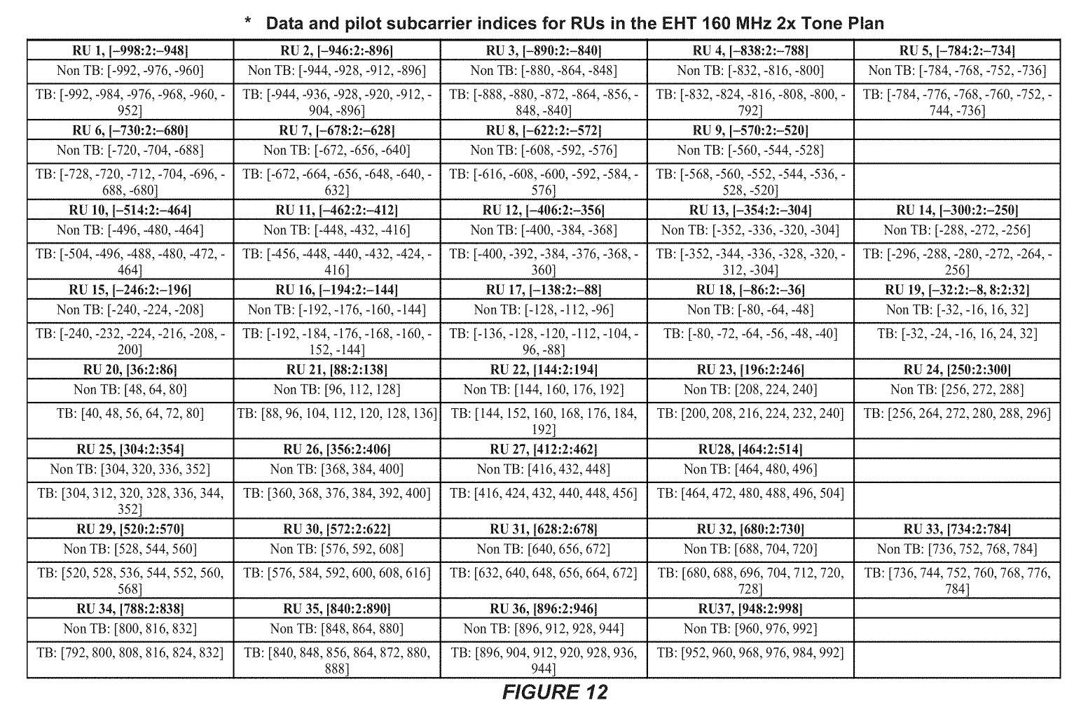

FIG. 12 shows an example breakdown of STF tones in 26-tone RUs for 160 MHz tone plan with 2× symbol duration. The breakdown indicates a mapping, in 4× symbol duration numerology, of STF tones in each 26-tone RU in EHT 160 MHz tone plan in 2× symbol duration, where 3-4 STF tones are used for the non-TB EHT-STFs and 6-7 STF tones for the TB EHT-STF are used.

### EHT STF Sequence Design

For 160 MHz and smaller channels, non-TB STF sequences may be used for non-TB PPDUs and TB STF sequences may be used for TB PPDUs. For the 160 MHz and 80+80 MHz modes in a total BW of 160 MHz, the concatenated STF sequence across segments may be denoted as [STF_0, STF_1], where STF_i is the STF sequence for the i-th lowest 80 MHz subchannel. In some implementations, the concatenated non-TB STF sequences for both the 160 MHz and 80+80 MHz modes are the same. For example, the concatenated non-TB STF sequences may be duplicates of two HE or other 80 MHz non-TB STF sequences for non-TB PPDUs, subject to a sign flip (i.e., 180 degree phase rotation) in one or more 40 MHz subchannels. In some implementations, the concatenated TB STF sequences for both the 160 MHz and 80+80 MHz modes are the same, where they may be duplicates of two HE or other 80 MHz TB STF sequences for TB PPDUs, subject to a sign flip (i.e., 180 degree phase rotation) in one or more 40 MHz subchannels. In some implementations, there may be no sign flip or phase rotation in the 0^{th} and 1^{st} lowest 40 MHz subchannel (i.e., the lowest 80 MHz subchannel), and the phase rotation coefficient may be predetermined to be −1 in the 2^{nd} lowest 40 MHz subchannel and +1 in the 3^{rd} lowest (i.e., upmost) 40 MHz subchannel, for both the non-TB STF sequences and the TB sequences.

For 240 and 320 MHz total BWs, in some implementations, the same non- TB STF sequence may be used for non-TB PPDUs and the same TB STF sequence could be used for TB PPDUs as described above, regardless of the symbol duration used for the data tone plan (for example, regardless of whether or not the tone plan is a 2× or 4× symbol duration tone plan). In some implementations, in modes that form a total 240 MHz BW, concatenated STF sequence across segments may be denoted as [STF_0, STF_1, STF_2], where STF_i is the STF sequence for the i-th lowest 80 MHz subchannel. In some implementations, the concatenated non-TB STF sequence is a duplication of three HE or other 80 MHz non-TB STF sequences for non-TB PPDUs, subject to a sign flip or phase rotation in one or more subchannels. In some implementations, the concatenated TB STF sequence is a duplication of three HE or other 80 MHz TB STF sequences for TB PPDUs, subject to a sign flip or phase rotation in one or more sub bands. In some implementations, in modes that form a total 320 MHz BW, concatenated STF sequence across segments may be denoted as [STF_0, STF_1, STF_2, STF_3], where STF_i is the STF sequence for the i-th lowest 80 MHz subchannel. In some implementations, the concatenated non-TB STF sequence is a duplication of four HE or other 80 MHz non-TB STF sequences for non-TB PPDUs, subject to a sign flip or phase rotation in one or more sub bands. In some implementations, the concatenated TB STF sequence is a duplication of four HE or other 80 MHz TB STF sequences for TB PPDUs, subject to a sign flip or phase rotation in one or more subchannels.

### Basic Concatenated STF Sequence

A basic concatenated STF sequence may involve the duplication of multiple HE or other 80 MHz STF sequences, without a sign flip or phase rotation in any subchannel. In some implementations, the basic concatenated STF sequence may be implemented for both non-TB and TB STF sequences. In some implementations, in 240 or 320 MHz total BWs, the basic concatenated STF sequence in a non-TB HE-STF sequence may include each of the 0^{th}, 1^{st}, and 2^{nd} lowest 80 MHz segments using HES_{-496:16:496}={M, 1, −M, 0, −M, 1, −M}*(1+j)/sqrt(2). In some implementations, in 240 or 320 MHz total BWs, the basic concatenated STF sequence in a TB HE-STF sequence may include each of the 0^{th}, 1^{st} 2^{nd} and 3^{rd} lowest 80 MHz segment using HES_{-504:8:504}={M, −1, M, −1, −M, −1, M, 0, −M, 1, M, 1, −M, 1, −M}*(1+j)/sqrt(2), HES₋504=0, HES₅₀₄=0.

### Phase Rotation Design

In some implementations, one or more concatenated STF sequences may include a sign flip or phase rotation. For example, one or more phase rotations, for example, +1, +j, −1, -j representing 0, 90, 180, 270 degree phase rotation, respectively, may be applied to a basic STF sequence in one or more subchannels of the 240 or 320 MHz total BW to minimize the peak-to-average-power ratio (PAPR) of the STF signal. In some implementations, the PAPR may be evaluated and used as a condition or factor in the contiguous 240 and 320 MHz BWs.

In some implementations, each 40 MHz subchannel may have its own phase rotation coefficient. The size of the subchannels used in the phase rotation design or EHT STF sequences may be based on one or more legacy systems subchannel sizes. In some implementations, the phase rotation coefficients in the non-TB STF and TB STF sequences may not be the same. In some implementations, the phase rotation coefficients in the total 160 MHz BW may not be part of or the same as those in the total 240 and 320 MHz BWs. In some implementations, the phase rotation coefficients in the total 240 MHz BW may not be part of or the same as those in the total 320 MHz BW. Accordingly, in an Option 0, random or trivial phase rotation coefficients may be applied to each 40 MHz subchannel. Alternatively, in an Option 0a, no phase rotation will be applied to each 40 MHz subchannel, meaning that the sequence is the basic concatenated STF sequences. In some implementations, the HE-STF is duplicated in 80 MHz for each 80 MHz subchannel. In some implementations, an Option 0b, may involve the 0^{th} and 2^{nd} 80 MHz subchannels having no phase rotation while the 1^{st} and 3^{rd} 80 MHz subchannels have the same phase rotations as the upper 80 MHz subchannel in 160 and 80+80 MHz subchannels in legacy systems. In some implementations, the EHT STF sequences may use the HE-STF in 80+80 MHz in the 0^{th} and 1^{st} lowest 80 MHz subchannels and in the 2^{nd} and 3^{rd} lowest 80 MHz subchannels.

In some implementations, an Option 1, involves no phase rotation in the 0^{th} and 1^{st} lowest 40 MHz subchannels (for example, the 0^{th} lowest 80 MHz subchannel). In some implementations, in the fourth option, other 40 MHz subchannel may have assigned phase rotation coefficients that are similar to or different from those in the 0^{th} and 1^{st} lowest 40 MHz subchannels. In some implementations, an Option 2, involves no phase rotation in the 0^{th} and 1^{st} lowest 40 MHz (for example, the 0^{th} lowest 80 MHz) subchannels. In some implementations, in the fifth option, the 2^{nd} and 3^{rd} lowest 40 MHz (for example, the 1^{st} lowest 80 MHz) sub bands use −1 and +1 as phase rotation coefficients, respectively. In some implementations, other 40 MHz subchannels may have assigned phase rotation coefficients that are the same as or different from those identified for the other 40 MHz subchannels of the fifth option. In some implementations, in the fifth option, the concatenated STF sequence of the 0^{th} and 1^{st} lowest 80 MHz is the same as that in 160 and 80+80 MHz subchannels in legacy systems. In some implementations, an Option 3 is applied in addition to the Option 2, further making the phase rotation coefficients in the non-TB STF sequence be the same as those in the TB STF sequence, for the same total BWs. In some implementations, an Option 4 is also applied in addition to Option 2 and further forces the 4^{th} and 5^{th} lowest 40 MHz (i.e., the 2^{nd} lowest 80 MHz) subchannels in the total 240 MHz BW to use the same phase rotation coefficients as those used in the total 320 MHz BW. In some implementations, an Option 5 is applied on top of Option 3, further forcing the 4^{th} and 5^{th} lowest 40 MHz (i.e., the 2^{nd} lowest 80 MHz) subchannels in total 240 MHz BWs to use same phase rotation coefficients as those in total 320 MHz BWs.

In some implementations, for non-TB HE-STF sequences with phase rotation coefficients a_coef(0:5), the 0^{th} lowest 80 MHz segment uses HES₋496:16:496={a_coef(0)*[M, 1, −M], 0, a_coef(1)*[−M, 1, −M]}*(1+j)/sqrt(2), and sets a_coef(0:1)=1. In some implementations, the 1^{st} lowest 80 MHz segment uses HES_{-496:16:496}={a_coef(2)*[M, 1, −M], 0, a_coef(3)*[−M, 1, −M]}*(1+j)/sqrt(2). In some implementations, the 2^{nd} lowest 80 MHz segment uses HES₋496:16:496={a. coef(4)*[M, 1, −M], 0, a_coef(5)*[−M, 1, −M]}*(1+j)/sqrt(2). In some implementations, for TB HE-STF sequences with phase rotation coefficients b_coef(0:5), the 0^{th} lowest 80 MHz segment uses HES_{-504:8:504}={b_coef(0)*[M, −1, M, −1, −M, −1, M], 0, b_coef(1)*[−M, 1, M, 1, −M, 1, −M]}*(1+j)/sqrt(2), HES₋₅₀₄=0, HES₅₀₄=0, and sets b_coef(0:1)=1. In some implementations, the 1^{st} lowest 80 MHz segment uses HES_{-504:8:504}={b_coef(2)*[M, −1, M, −1, −M, −1, M], 0, b_ coef(3)*[−M, 1, M, 1, −M, 1, −M]}*(1+j)/sqrt(2), HES₋₅₀₄=0, HES₅₀₄=0. In some implementations, the 2^{nd} lowest 80 MHz segment uses HES_{-504:8:504}={b_coef(4)*[M, −1, M, −1, −M, −1, M], 0, b_coef(5)*[−M, 1, M, 1, −M, 1, −M]}*(1+j)/sqrt(2), HES₋₅₀₄=0, HES₅₀₄=0. Accordingly, based on the options identified above, in some implementations, for Option 0a: a_coef(0:5)=1, b_coef(0:5)=1. In some implementations, for Option 0b: a_coef(0:1)=1, a_coef(3:5)=1, a_coef(2)=−1, b_coef(0:1)=1, b_coef(3:5)=1, b_coef(2)=−1. In some implementations, for Option 1: Set a_coef(0:1)=1 and b_coef(0:1)=1. In some implementations, in Option 1, a_coef(2:5) and b_coef(2:5) are unassigned, resulting in 8 unknown coefficients. In some implementations, for Option 2: Set a_coef(0:1)=1, a_coef(2)=−1, a_coef(3)=1, b_coef(0:1)=1, b_coef(2)=−1, b_coef(3)=1. In some implementations, in Option 2, a_coef(4:5) and b_coef(4:5) are unassigned, resulting in 4 unknown coefficients.

In some implementations, for non-TB HE-STF sequences with phase rotation coefficients c_coef(0:7), the 0^{th} lowest 80 MHz segment uses HES_{-496:16:496}={c_ coef(0)*[M, 1, −M], 0, c_coef(1)*[−M, 1, −M]}*(1+j)/sqrt(2), and sets c_coef(0:1)=1. In some implementations, the 1^{st} lowest 80 MHz segment uses HES_{-496 16:496}={c_coef(2)*[M, 1, −M], 0, c_coef(3)*[−M, 1, −M]}*(1+j)/sqrt(2). In some implementations, the 2^{nd} lowest 80 MHz segment uses HES_{496:16:496}={c_coef(4)*[M, 1, −M], 0, c_coef(5)*[−M, 1, −M]}*(1+j)/sqrt(2). In some implementations, the 3^{rd} lowest 80 MHz segment uses HES_{-496:16:496}={c_coef(6)*[M, 1, −M], 0, c_coef(7)*[−M, 1, −M]}*(1+j)/sqrt(2). In some implementations, for TB HE-STF sequences with phase rotation coefficients d_coef(0:7), the 0^{th} lowest 80 MHz segment uses HES_{-504:8:504}={d_coef(0)*[ M, −1, M, −1, −M, −1, M], 0, d_coef(1)*[−M, 1, M, 1, −M, 1, −M]}*(1+j)/sqrt(2), HES₋₅₀₄=0, HES₅₀₄=0, and sets d_coef(0:1)=1. In some implementations, the 1^{st} lowest 80 MHz segment uses HES_{-504:8:504}={d_coef(2)*[M, −1, M, −1, −M, −1, M], 0, d_coef(3)*[−M, 1, M, 1, −M]}, 1, −M]}*(1+j)/sqrt(2), HES₋₅₀₄=0, HES₅₀₄=0. In some implementations, the 2^{nd} lowest 80 MHz segment uses HES_{-504:8:504}={d_coef(4)*[M, −1, M, −1, −M, −1, M], 0, d_coef(5)*[−M, 1, M, 1, −M, 1, −M]}*(1+j)/sqrt(2), HES₋₅₀₄=0, HES₅₀₄=0. In some implementations, the 3^{rd} lowest 80 MHz segment uses HES_{-504:8:504}={d_coef(6)*[M, −1, M, −1, −M, −1, M], 0, d_coef(7)*[−M, 1, M, 1, −M, 1, −M]}*(1+j)/sqrt(2), HES₋₅₀₄=0, HES₅₀₄=0. Accordingly, based on the options identified above, in some implementations, for Option Oa: c_coef(0:7)=1, d_coef(0:7)=1. In some implementations, for Option 0b: c_coef(0:1)=1, c_coef(3:5)=1, c_coef(2)=−1, c_coef(6)=−1, c_coef(7)=1, d_coef(0:1)=1, d_coef(3:5)=1, d_coef(2)=−1, d_coef(6)=−1, d_coef(7)=1. In some implementations, for Option 1: Set c_coef(0:1)=1 and d_coef(0:1). In some implementations, in Option 1, c_coef(2:7) and d_coef(2:7) are unassigned, resulting in 12 unknown coefficients. In some implementations, for Option 2: Set c_coef(0:1)=1, c_coef(2)=−1, c_coef(3)=1, d_coef(0:1)=1, d_coef(2)=−1, d_coef(3)=1. In some implementations, in Option 2, c_coef(4:7) and d_coef(4:7) are unassigned, resulting in 8 unknown coefficients. In some implementations, for Option 3: Set Set a_coef(0:1)=1, a_coef(2)=−1, a_coef(3)=1, b_coef(0:1)=1, b_coef(2)=−1, b_coef(3)=1, c_coef(0:1)=1, c_coef(2)=−1, c_coef(3)=1, d_coef(0:1)=1, d_coef(2)=−1, d_coef(3)=1. In some implementations, in Option 2, a_coef(4:5), b_coef(4:5), c_coef(4:7) and d_coef(4:7) are unassigned subject to a_coef(4:5)=b_coef(4:5) and c_coef(4:7)=d_coef(4:7), resulting in 6 unknown coefficients. In some implementations, for Option 4: Set a_coef(0:1)=1, a_coef(2)=−1, a_coef(3)=1, b_coef(0:1)=1, b_coef(2)=−1, b_coef(3)=1, c_coef(0:1)=1, c_coef(2)=−1, c_coef(3)=1, d_coef(0:1)=1, d_coef(2)=−1, d_coef(3)=1. In some implementations, in Option 4, a_coef(4:5), b_coef(4:5), c_coef(4:7) and d_coef(4:7) are unassigned subject to a_coef(4:5)=c_coef(4:5) and b_coef(4:5)=d_coef(4:5), resulting in 8 unknown coefficients. In some implementations, for Option 5: Set a_coef(0:1)=1, a_coef(2)=−1, a_coef(3)=1, b_coef(0:1)=1, b_coef(2)=−1, b_coef(3)=1, c_coef(0:1)=1, c_coef(2)=−1, c_coef(3)=1, d_coef(0:1)=1, d_coef(2)=−1, d_coef(3)=1. In some implementations, in Option 5, a_coef(4:5), b_coef(4:5), c_coef(4:7) and d_coef(4:7) are unassigned subject to a_coef(4:5)=b_coef(4:5)=c_coef(4:5)=d_coef(4:5) and c_coef(6:7)=d_coef(6:7), resulting in 4 unknown coefficients.

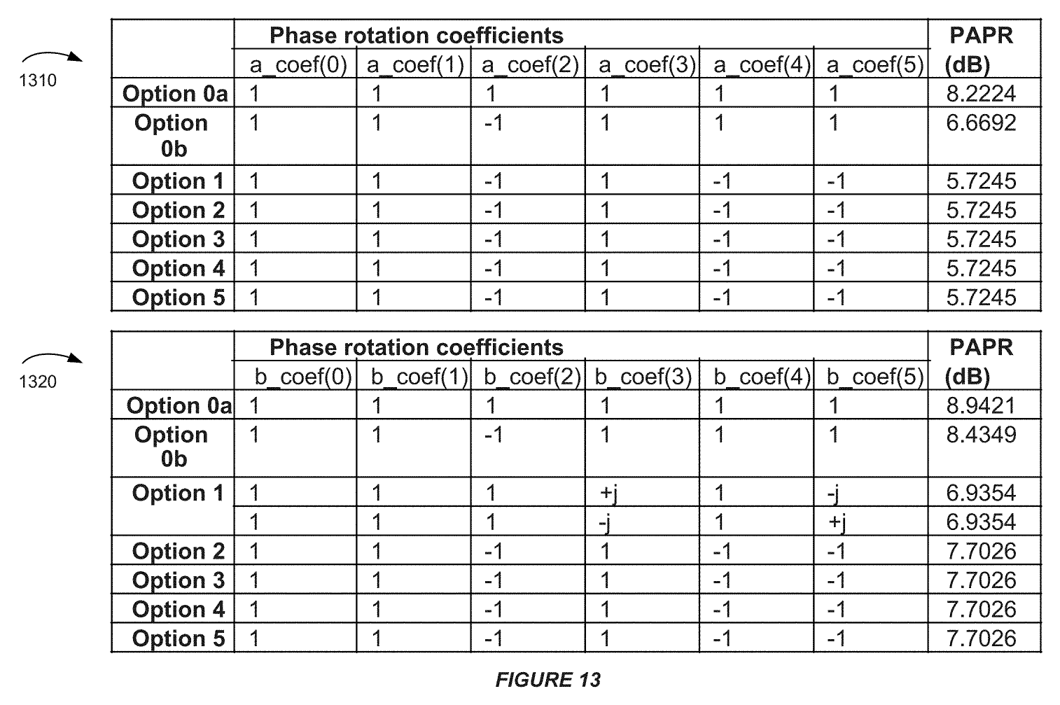

FIG. 13 shows example phase rotation coefficients for 240 MHz non-trigger based (TB) and TB STF sequences. A first table 1310 shows an example STF TB sequence for 240 MHz. A second table 1320 shows an example STF TB sequence for 240 MHz. In some implementations, the phase rotation coefficients shown are optimized in 240 MHz non-TB STF and TB STF sequences.

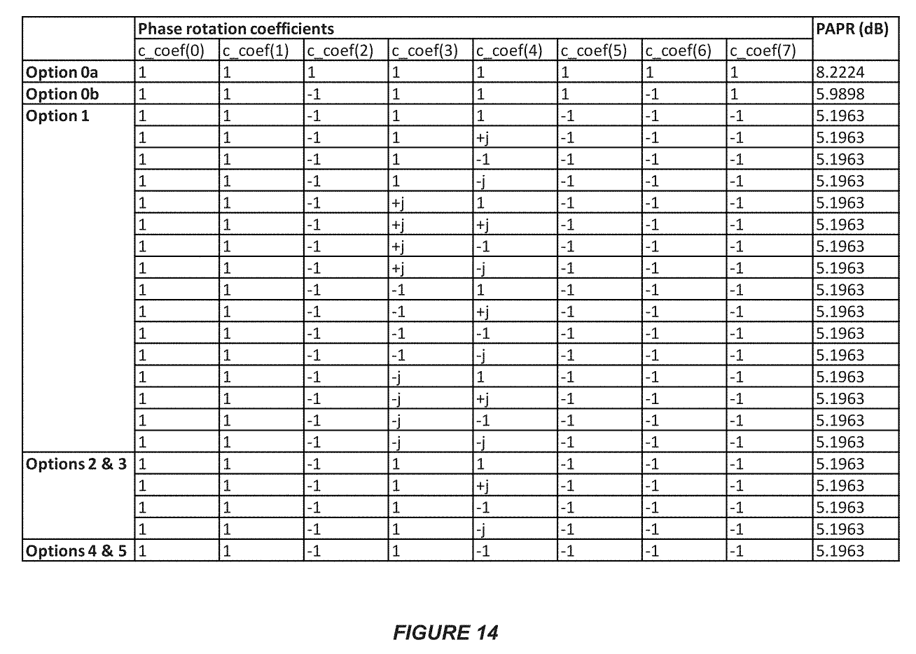

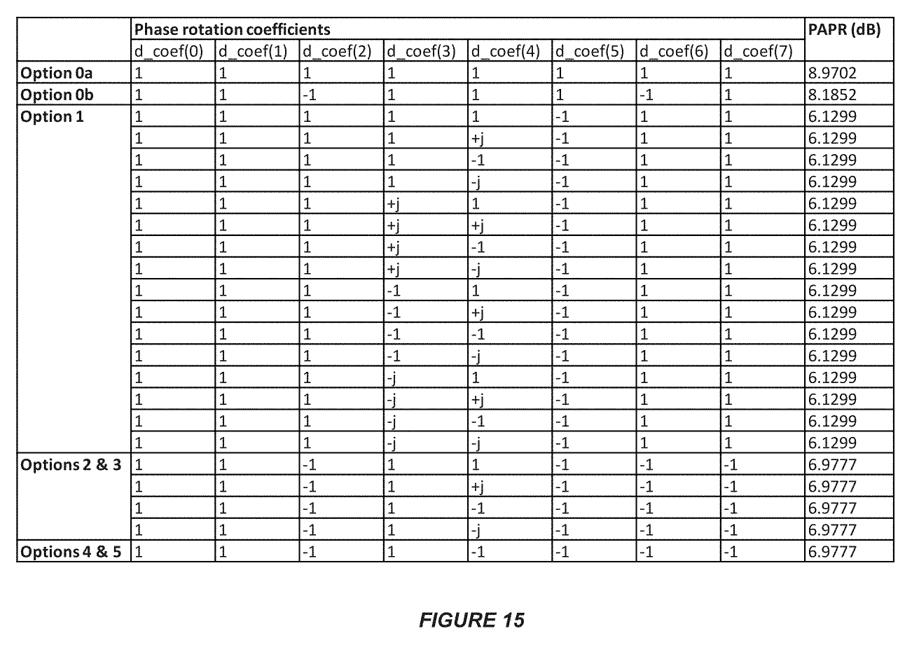

Some example values for the coefficients are given in FIG. 13 for non-TB and TB STF sequences of 240 Mhz, in FIG. 14 for non-TB STF sequence of 320 MHz, and in FIG. 15 for TB STF sequence of 320 Mhz.

FIG. 14 shows example phase rotation coefficients for a 320 MHz non-TB STF sequence. In some implementations, the phase rotation coefficients shown are optimized in 320 MHz non-TB STF sequences.

FIG. 15 shows example phase rotation coefficients for a 320 MHz TB STF sequence. In some implementations, the phase rotation coefficients shown are optimized in 320 MHz TB STF sequences.

### EXAMPLE STF SEQUENCES

Below are several example sub-STF sequences for various channel sizes using 4× numerology. As described herein, these sub-STF sequences may be duplicated, concatenated, phase rotated, or any combination thereof, to form an STF sequence for a 240 MHz or 320 MHz channel.
For the HE-STF field, the M sequence is defined as
M={−1, −1, −1, 1, 1, 1, −1, 1, 1, 1, −1, 1, 1, −1, 1}
For 20 MHz channel:

Non TB HE-STF sequence: HES_{-112:16 112}=M*(1+j)/sqrt(2), HES₀=0

TB HE-STF sequence: HES_{-120:8120}={M, 0, −M}*(1+j)/sqrt(2)
For 40 MHz channel:

Non TB HE-STF sequence: HES_{-240:16:240}={M, 0, −M}*(1+j)/sqrt(2)

TB HE-STF sequence: HES_{-248:8:248}={M, −1, −M, 0, M, −1, M}*(1+j)/sqrt(2), HES₋₂₄₈=0, HES₂₄₈=0
For 80 MHz channel:

Non TB HE-STF sequence: HES_{-496:16:496}={M, 1, −M, 0, −M, 1, −M}*(1+j)/sqrt(2)

TB HE-STF sequence: HES_{-504 8 504}={M, −1, M, −1, −M, −1, M, 0, −M, 1, M, 1, −M, 1, −M}*(1+j)/sqrt(2), HES₋₅₀₄=0, HES₅₀₄=0
For 160 MHz channel:

Non TB HE-STF sequence: HES_{-1008:16:1008}={M, 1, −M, 0, −M, 1, −M, 0, −M, −1, M, 0, −M, 1, −M}*(1+j)/sqrt(2)

TB HE-STF sequence: HES_{-1016 8:1016}={M, −1, M, −1, −M, −1, M, 0, −M, 1, M, 1, −M, 1, −M, 0, −M, 1, −M, 1, M, 1, −M, 0, −M, 1, M, 1, −M, 1, −M}*(1+j)/sqrt(2),

HES₋₁₀₁₆=0, HES₋₈=0, HES₈=0, HES₁₀₁₆=0
For 80+80 MHz channel:

Non TB HE-STF sequence: the lower 80 MHz segment uses HES_{-496:16:496}={M, 1, −M, 0, −M, 1, −M}*(1+j)/sqrt(2), while the upper 80 MHz segment uses HES_{-496:16:496}={−M, −1, M, 0, −M, 1, −M}*(1+j)/sqrt(2)

TB HE-STF sequence: the lower 80 MHz segment uses HES_{-504:8:504}={M, −1, M, −1, −M, −1, M, 0, −M, 1, M, 1, −M, 1, −M}*(1+j)/sqrt(2), HES_{-504=0,} HES₅₀₄=0, while the upper 80 MHz segment uses HES_{-504 8 504}={−M, 1, −M, 1, M, 1, −M, 0, −M, 1, M, 1, −M, 1, −M}*(1+j)/sqrt(2), HES_{-504=0,} HES₅₀₄=0

For an OFDMA transmission, the coefficients in the STF sequences are set to zero if those values are corresponding to tone indices that fall within RUs that have no users assigned to them.

### EXAMPLE TRIGGER BASED (TB) FEEDBACK NDP STF SEQUENCES

Below are several example HE TB feedback NDP STF sequences for various channel sizes. As described herein, these STF sequences may be used as sub-STF sequences to form an STF sequence for a 240 MHz or 320 MHz channel. The sub-STF sequences be duplicated, concatenated, phase rotated, or any combination thereof, to form the STF sequence.

### HE TB Feedback NDP STF Sequences

For an HE TB feedback NDP in 20 MHz channel width, the STF sequence is given by
HES_{-120:8:120}^{TB NDP}=HES_{-120:8:120}, where HES_{-120:8:120} is the HE TB STF sequence in 20 MHz channel.
For an HE TB feedback NDP in 40 MHz channel width, the STF sequence is given by
HES_{-248:8:-8}^{TB NDP}={M, −1, −M}·(1+j)/\sqrt{2}, if RU_TONE_SET_INDEX≤18
HES_{8:8:248}^{TB NDP}={M, −1, M}·(1+j)/\sqrt{2}, if RU_TONE_SET_INDEX≤18
HES_{±248}^{TB NDP}=0

For an HE TB feedback NDP in 80 MHz channel width, the STF sequence is given by
HES_{-504:8:-264}^{TB NDP}={M, −1, M}·(1+j)/\sqrt{2}, if RU_TONE_SET_INDEX≤18
HES_{248:8:-8}^{TB NDP}={−M, −1, M}·(1+j)/\sqrt{2}, if 18<RU_TONE_SET_INDEX≤36
HES_{8:8:248}^{TB NDP}={−M, 1, M}·(1+j)/\sqrt{2}, if 36<RU_TONE_SET_INDEX≤54
HES_{264:8:504}^{TB NDP={-,} 1, −M}·(1+j)/\sqrt{2}, if 54<RU_TONE_SET_INDEX≤72
HES_{±504}^{TB NDP}=0
For an HE TB feedback NDP in 160 MHz channel width, the STF sequence is given by
HES_{-1016:8:-776}^{TB NDP}={M, −1, M}·(1+j)/\sqrt{2}, if RU_TONE_SET_INDEX≤18
HES_{760:8:-520}^{TB NDP}={−M, 1, M}·(1+j)/\sqrt{2}, if 18 <RU_TONE_SET_INDEX≤36
HES_{-504:8:-264}^{TB NDP}={−M, 1, M}·(1+j)/\sqrt{2}, if 36<RU_TONE_SET_INDEX≤54
HES_{-248:8:-8}^{TB NDP}={−M, 1, −M}·(1+j)/\sqrt{2}, if 54<RU_TONE_SET_INDEX≤72
HES_{8:8:248}^{TB NDP}={−M, 1, −M}·(1+j)/\sqrt{2}, if 72<RU_TONE_SET_INDEX≤90
HES_{264:8:504}^{TB NDP}={M, 1, −M}·(1+j)/\sqrt{2}, if 90<RU_TONE_SET_INDEX≤108
HES_{520:8:760}^{TB NDP}={−M, 1, M}·(1+j)/\sqrt{2}, if 108<RU_TONE_SET_INDEX≤126
HES_{776:8:1016}^{TB NDP}{−M, 1, −M}·(1+j)/\sqrt{2}, if 126<RU_TONE_SET_INDEX≤144
HES_{±8}^{TB NDP}=HES₁₀₁₆^{TB NDP}=0
For an HE TB feedback NDP in the lower 80 MHz segment of an 80+80 MHz channel width, the STF sequence is same as that of an 80 MHz channel width.
For an HE TB feedback NDP in the upper 80 MHz segment of an 80+80 MHz channel width, the STF sequence is given by
HES_{-504:8:-264}^{TB NDP}={−M, 1, −M}·(1+j)/\sqrt{2}, if RU_TONE_SET_INDEX≤90
HES_{-248:8:-8}^{TB NDP}={M, 1, −M}·(1+j)/\sqrt{2}, if 90<RU_TONE_SET_INDEX≤108
HES_{8:8:248}^{TB NDP}={−M, 1, M}·(1+j)/\sqrt{2}, if 108<RU_TONE_SET_INDEX≤126
HES_{264:8:504}^{TB NDP}={−M, 1, −M}·(1+j)/b \sqrt{2}, if 126<RU_TONE_SET_INDEX≤144
HEST_{±504}^{TB NDP}=0
If a 20 MHz operating non-AP STA sends an HE TB feedback NDP report response on a channel width greater than 20 MHz, the HE-STF tone which overlaps with the DC tone of the 20 MHz operating non-AP STA is not transmitted.

For an OFDMA transmission or preamble puncturing scenario, the coefficients in the above equations are set to zero if those values are corresponding to tone indices that fall within RUs that have no users assigned to them.

The design of EHT TB feedback NDP STF sequences for 240 MHz and 320 MHz channels may depend on the design of EHT TB STF sequences. Below are example formulas for the EHT TB feedback NDP STF sequences which show that the EHT TB feedback NDP STF sequences are functions of EHT TB STF sequences. Therefore, an optimum design of the TB STF sequence (with particular phase rotations for various sub-STFs) may be applicable to the designs of the EHT TB feedback NDP STF sequences.

### EHT TB Feedback NDP STF Sequence Design

The STF sequence for each RU_TONE_SET_INDEX in the HE TB feedback NDP may be taken as a subsequence from the HE TB STF sequence of a channel bandwidth, with corresponding tone index range.

For EHT, the STF sequence for each RU_TONE_SET_INDEX in the EHT TB feedback NDP may be taken as a subsequence from the EHT TB STF sequence of a channel bandwidth, with corresponding tone index range. Therefore, the EHT TB feedback NDP STF sequences for existing bandwidths (20 MHz, 40 MHz, 80 MHz, 160 MHz, or 80+80 MHz) may be same as the HE TB feedback NDP STF sequences.

For total 240 MHz, suppose the RU_TONE_SET_INDEX may be defined for values from 1 to 216. For total 320 MHz, suppose the RU_TONE_SET_INDEX may be defined for values from 1 to 288.

For total 240 MHz, for the concatenated TB STF sequence, the artificial tone index range is [−2048, 1023]. Denote the concatenated TB STF sequence as HES_{240 MHz}=HES_{-2040:8:1016}. For a contiguous 240 MHz channel, the TB feedback NDP STF sequence is given by
HES_{2040:8:-1800}=HES_{-2048:8:-1800}, if RU_TONE_SET_INDEX≤18
HES_{-1748:8:-1544}=HES_{-1784:8:-1544}, if 18<RU_TONE_SET_INDEX≤36
HES_{-1528:8:-1288}^{TB NDP}=HES_{-1528:8:-1288}, if 36<RU_TONE_SET_INDEX≤54
HES_{-1272:8:-1032}^{TB NDP}=HES_{-1272:8:-1032}, if 54<RU_TONE_SET_INDEX≤72
HES_{-1016:8:-776}^{TB NDP}=HES_{-1016:-776}, if 72<RU_TONE_SET_INDEX≤90
HES_{-760:8:-520}^{TB NDP}=HES_{-760:8:-520}, if 90<RU_TONE_SET_INDEX≤108
HES_{-504:8:-264}^{TB NDP}=HES_{-504:8:-264}, if 108<RU_TONE_SET_INDEX≤126
HES_{248:8:-8}=HES_{-248:8:-8}, if 126<RU_TONE_SET_INDEX≤144
HES_{8:8:248}^{TB NDP}=HES_{8:8:248}, if 144<RU_TONE_SET_INDEX≤162
HES_{264:8:504}^{TB NDP}=HES_{264:8:504}, if 162<RU_TONE_SET_INDEX≤180
HES_{520:8:760}^{TB NDP}=HES_{520:8:760}, if 180<RU_TONE_SET_INDEX≤198
HES_{776:8:1016}^{TB NDP}=HES_{776:8:1016}, if 198<RU_TONE_SET_INDEX≤216
For a non-contiguous 160+80 MHz channel, where the 160 MHz subchannel is in lower frequency and the 80 MHz subchannel is in upper frequency, the TB feedback
NDP STF sequence of the lower 160 MHz subchannel is given by
HES_{-1016:8:-776}^{TB NDP}=HES_{-2040:8:-1800}, if RU_TONE_SET_INDEX≤18
HES_{-760:8:-520}^{TB NDP}=HES_{-1784:8:1544}, if 18<RU_TONE_SET_INDEX≤36
HES_{-504:8:-264}^{TB NDP}=HES_{-1528: 8:-1288}, if 36<RU_TONE_SET_INDEX≤54
HES_{-248:8:-8}^{TB NDP}=HES_{-1272:8:1032}, if 54<RU_TONE_SET_INDEX≤72
HES_{8:8:248}^{TB NDP}=HES_{-1016:8:-776}, if 72<RU_TONE_SET_INDEX≤90
HES_{264:8:504}^{TB NDP}=HES_{-760:8:-520}, if 90<RU_TONE_SET_INDEX≤108
HES_{520:8:760}^{TB NDP}=HES_{-504:8:-264}, if 108<RU_TONE_SET_INDEX≤126
HES_{776:8:1016}^{TB NDP}=HES_{248:8:-8}, if 126<RU_TONE_SET_INDEX≤144
And the TB feedback NDP STF sequence of the upper 80 MHz is given by
HES_{504:8:-264}^{TB NDP}=HES_{8:8:248}, if 144<RU_TONE_SET_INDEX≤162
HES_{248:8:-8}^{TB NDP}=HES_{264:8:504}, if 162<RU_TONE_SET_INDEX≤180
HES_{8:8:248}^{TB NDP}=HES_{520:8:760}, if 180<RU_TONE_SET_INDEX≤198
HES_{264:8:504}^{TB NDP}=HES_{776:8:1016}, if 198<RU_TONE_SET_INDEX≤216
For a non-contiguous 160+80 MHz channel, where the 80 MHz subchannel is in lower frequency and the 160 MHz subchannel is in upper frequency, the TB feedback NDP STF sequence of the lower 80 MHz subchannel is given by
HES_{-504:8:-264}^{TB NDP}=HES_{-2040:8:-1800}, if RU_TONE_SET_INDEX≤18
HES_{-248:8:-8}^{TB NDP}=HES_{-1784:8:-1544}, if 18<RU_TONE_SET_INDEX≤36
HES_{8:8:248}^{TB NDP}=HES_{-1528:8:-1288}, if 36<RU_TONE_SET_INDEX≤54
HES_{264:8:504}^{TB NDP}=HES_{-1272:8:-}1032, if 54<RU_TONE_SET_INDEX≤72
And the TB feedback NDP STF sequence of the upper 160 MHz is given by
HES_{-1-16:8:-776}^{TB NDP}=HES_{-1016:8:-776}, if 72<RU_TONE_SET_INDEX≤90
HES_{76:8:-520}^{TB NDP}=HES_{-760:8:-520}, if 90<RU_TONE_SET_INDEX≤108
HES_{-504:8:-264}^{TB NDP}HES_{-504:8:-264}, if 108<RU_TONE_SET_INDEX≤126
HES_{-248:8:-8}^{TB NDP}=HES_{-248:8:-8}, if 126<RU_TONE_SET_INDEX≤144
HES_{8:8:248}^{TB NDP}=HES_{8:8:248}, if 144<RU_TONE_SET_INDEX≤162
HES_{264:8:504}^{TB NDP}=HES_{264:8:504}, if 162<RU_TONE_SET_INDEX≤180
HES_{520:8:760}^{TB NDP}=HES_{520:8:760}, if 180<RU_TONE_SET_INDEX≤198
HES_{776:8:1016}^{TB NDP}=HES_{776:8:1016}, if 198<RU_TONE_SET_INDEX≤216
For a non-contiguous 80+80+80 MHz channel, the TB feedback NDP STF sequence of the lowest 80 MHz subchannel is the same as that of the lower 80 MHz subchannel in the 160+80 MHz channel where the 80 MHz subchannel is in lower frequency. And the TB feedback NDP STF sequence of the second lowest 80 Mhz subchannel is given by
HES_{-504:8:-264}^{TB NDP}=HES_{-1016:8:-776}, if 72<RU_TONE_SET_INDEX≤90
HES_{-248:8:-8}^{TB NDP}=HES_{-760:8:-520}, if 90<RU_TONE_SET_INDEX≤108
HES_{8:8:248}^{TB NDP}=HES_{-504:8:-264}, if 108<RU_TONE_SET_INDEX≤126
HES_{264:8:504}^{TB NDP}=HES_{-248:8:-8}, if 126<RU_TONE_SET_INDEX≤144
And the TB feedback NDP STF sequence of the upper 80 MHz is the same as that of the upper 80 Mhz subchannel in the 160+80 MHz channel where the 80 MHz subchannel in is upper frequency.
For total 320 MHz, for the concatenated TB STF sequence, the artificial tone index range is [−2048, 2047]. Denote the concatenated TB STF sequence as HES_{320 MHz}=HES_{-2040:8:2040}. For a contiguous 240 MHz channel, the TB feedback NDP STF sequence is given by
HES_{-2038:8:—1800}^{TB NDP}=HES_{-2040:8:-1800}, if RU_TONE_SET_INDEX≤18
HES_{-1748:8:-1544}^{TB NDP}=HES_{-1748:8:-1544}, if 18<RU_TONE_SET_INDEX≤36
HES_{-1528:8:-1288}^{TB NDP}=HES_{-1528:8:-1288}, if 36<RU_TONE_SET_INDEX≤54
HES_{-1272:8:-1032}^{TB NDP}=HES_{-1272:8:-1032}, if 54<RU_TONE_SET_INDEX≤72
HES_{-1016:8:-776}^{TB NDP}=HES_{-1016:8:-776}, if 72<RU_TONE_SET_INDEX≤90
HES_{-760:8:-520}^{TB NDP}=HES_{-760:8:-520}, if 90<_{RU_TONE_SET_INDEX≤}108
HES_{-504:8:-264}^{TB NDP}=HES_{-504:8:-264}, if 108<RU_TONE_SET_INDEX≤126
HES_{-248:8:-8}^{TB NDP}=HES_{-248:8:-8}, if 126<RU_TONE_SET_INDEX≤144
HES_{8:8:248}^{TB NDP}=HES_{8:8:248}, if 144<RU_TONE_SET_INDEX≤162
HES_{264:8:504}^{TB NDP}=HES_{264:8:504}, if 162<RU_TONE_SET_INDEX≤180
HES^{520:8:760}^{TB NDP}=HES_{520:8:760}, if 180<RU_TONE_SET_INDEX≤198
HES_{776:8:1016}^{TB NDP}=HES_{776:8:1016}, if 198<RU_TONE_SET_INDEX≤216
HES_{1032:8:1272}^{TB NDP}=HES_{1032:8:1272}, if 216<RU_TONE_SET_INDEX≤234
HES_{1288:8:1528}^{TB NDP}=HES_{1288:8:1528}, if 234<RU_TONE_SET_INDEX≤252
HES_{1544:8:1784}^{TB NDP}=HES_{1544:8:1784}, if 252<RU_TONE_SET_INDEX≤270
HES_{1800:8:2040}^{TB NDP}=HES_{1800:8:2040}, if 270<RU_TONE_SET_INDEX≤288
a non-contiguous 160+160 MHz channel, the TB feedback NDP STF sequence of the lower 160 MHz subchannel is given by
HES_{-1016:8:-776}^{TB NDP}=HES_{-2048:8:-1800}, if RU_TONE_SET_INDEX≤18
HES_{-760:8:-520}^{TB NDP}=HES_{-1784:8:-1544}, if 18<RU_TONE_SET_INDEX≤36
HES_{-504:8:-264}^{TB NDP}=HES_{-1528:8:-1288}, if 36<RU_TONE_SET_INDEX≤54
HES_{-2488:8:-8}^{TB NDP}=HES_{-1272:8:-1032}, if 54<RU_TONE_SET_INDEX≤72
HES_{8:8:248}^{TB NDP}=HES_{-1016:8:-776,} if 72<RU_TONE_SET_INDEX≤90
HES_{264:8:504}^{TB NDP}=HES_{-760:8:-520}, if 90<RU_TONE_SET_INDEX≤108
HES_{520:8:760}^{TB NDP}=HES_{504:8:-}264, if 108<RU_TONE_SET_INDEX≤126
HES_{776:8:1016}^{TB NDP}=HES_{-248:8:-8}, if 126<RU_TONE_SET_INDEX≤144
And the TB feedback NDP STF sequence of the upper 160 Mhz is given by
HES_{-1016:8:-776}^{TB NDP}=HES_{8:8:248}, if 144<RU_TONE_SET_INDEX≤162
HES_{-760:8:-520}^{TB NDP}=HES_{264:8:504}, if 162<RU_TONE_SET_INDEX≤180
HES_{-504:8:-264}^{TB NDP}=HES_{520:8:760}, if 180<RU_TONE_SET_INDEX≤198
HES_{-248:8:-8}^{TB NDP}=HES_{776:8:1016}, if 198<RU_TONE_SET_INDEX<216
HES_{8:8:248}^{TB NDP}=HES_{1032:8:1272}, if 216<RU_TONE_SET_INDEX≤234
HES_{264:8:504}^{TB NDP}=HES_{1288:8:1528}, if 234<RU_TONE_SET_INDEX≤252
HES_{520:8:760}^{TB NDP}=HES_{1544:8:1784}, if 252<RU_TONE_SET_INDEX≤270
HES_{776:8:1016}^{TB NDP}=HES_{1800:8:2040}, if 270<RU_TONE_SET_INDEX≤288
For a non-contiguous 160+80+80 MHz channel, where the 160 MHz subchannel is in lowest frequency, the TB feedback NDP STF sequence of the lower 160 MHz subchannel is same as that of the lower 160 MHz subchannel in the 160+160 Mhz channel. And the TB feedback NDP STF sequence of the middle 80 Mhz subchannel is given by
HES_{-504:8:-264}^{TB NDP}=HES_{8:8:248}, if 144<RU_TONE_SET_INDEX≤162
HES_{-2488:8-8}=HES_{264:8:504}, if 162<RU_TONE_SET_INDEX≤180
HES_{8:8:248}^{TB NDP}=HES_{520:8:760}, if 180<RU_TONE_SET_INDEX≤198
HES_{264:8:504}^{TB NDP}=HES_{776:8:1016}, if 198<RU_TONE_SET_INDEX≤216
And the TB feedback NDP STF sequence of the upper 80 MHz subchannel is given by
HES_{-504:8:-264}^{TB NDP}=HES_{1032:8:1272}, if 216<RU_TONE_SET_INDEX≤234
HES_{-248:8:-8}^{TB NDP}=HES_{1288:8:1528}, if 234<RU_TONE_SET_INDEX≤252
HES_{8:8:248}^{TB NDP}=HES_{1544:8:1784}, if 252<RU_TONE_SET_INDEX≤270
HES_{26:8:504}^{TB NDP}=HES_{1800:8:2040}, if 270<RU_TONE_SET_INDEX≤288
For a non-contiguous 160+80+80 MHz channel, where the 160MIlz subchannel is in middle frequency, the TB feedback NDP STF sequence of the lower 80MIlz subchannel is given as
HES₋₅₀₄₈₋₂₆₄^{TB NDP}=HES_{-2040:8:-1800}, if RU_TONE_SET_INDEX≤18
HES_{248:8:-8}^{TB NDP}=HES_{-1784:8:-1544}, if 18<RU_TONE_SET_INDEX≤36
HES_{8:8:248}^{TB NDP}=HES_{-1528:8:-1288}, if 36<RU_TONE_SET_INDEX≤54
HES_{264:8:504}^{TB NDP}=HES_{-1272:8:8:-1032}, if 54<RU_TONE_SET_INDEX≤72
And the TB feedback NDP STF sequence of the middle 160 Mhz subchannel is given as
HES_{-1016:8:-776}^{TB NDP}=HES_{-1016:8:-776}, if 72<RU_TONE_SET_INDEX≤90
HES_{760:8:-520}^{TB NDP}=HES_{-760:8:-520}, if 90<RU_TONE_SET_INDEX≤108
HES_{-504:8:-264}^{TB NDP}=HES_{-504:8:-264}, RU_TONE_SET_INDEX≤126
HES_{-248:8:-8}^{TB NDP}=HES_{-248:8:-8}, if 126<RU_TONE_SET_INDEX≤144
HES_{8:8:248}^{TB NDP}=HES_{8:8:248}, if 144<RU_TONE_SET_INDEX≤162
HES_{264:8:504}^{TB NDP}=HES_{264:8:504}, if 162_{<}RU_TONE_SET_INDEX≤180
HES₅₂₀₈₇₆₀^{TB NDP}=HES_{520:8:760}, if 180<RU_TONE_SET_INDEX≤198
HES_{776:8:8}^{TB NDP}=HES_{776:8:1016}, if 198<RU_TONE_SET_INDEX<216
And the TB feedback NDP STF sequence of the upper 80 Mhz subchannel is same as that of the upper 80 Mhz subchannel in the 160+80+80 MHz channel, where the 160 Mhz subchannel is in lowest frequency.
For a non-contiguous 160+80+80 MHz channel, where the 160 MHz subchannel is in upper frequency, the TB feedback NDP STF sequence of the lowest 80 MHz subchannel is same as that of the lowest 80 Mhz subchannel in the 160+80+80 MHz channel, where the 160 Mhz is in the middle frequency. And the TB feedback NDP STF sequence of the second lowest 80 MHz subchannel is given as
HES_{-504:8:-264}^{TB NDP}=HES_{-1016:8:-776}, if 72<RU_TONE_SET_INDEX≤90
HES_{-504:8:-264}^{TB NDP}=HES_{-760:8:-520}, if 90<RU_TONE_SET_INDEX≤108
HES_{264:8:504}^{TB NDP}=HES_{-504:8:-264}, if 108<RU_TONE_SET_INDEX≤126

And the TB feedback NDP STF sequence of the 160 MHz subchannel is same as that of the upper 160 MHz subchannel in the 160+160 MHz channel.
For a non-contiguous 80+80+80+80 Mhz channel, the TB feedback NDP STF sequences of the lowest and the second lowest 80 Mhz subchannels are same as those in the 160+80+80 MHz channel, where the 160 MHz subchannel is in upper frequency. And the TB feedback NDP STF sequences of the third lowest 80 MHz and upper 80 MHz subchannels are same as those in the 160+80+80 MHz channel, where the 160 MHz subchannel is in the lower frequency.

If a 20 MHz operating non-AP STA sends an HE TB feedback NDP report response on a channel width greater than 20 MHz, the HE-STF tone which overlaps with the DC tone of the 20 MHz operating non-AP STA is not transmitted.

For an OFDMA transmission or preamble puncturing scenario, the coefficients in the above equations are set to zero if those values are corresponding to tone indices that fall within RUs that have no users assigned to them.

### EHT Long Training Field (LTF) Sequences Design

The EHT LTF sequences for 2× and 4× symbol duration tone plans may be designed as described herein and may apply to all bandwidth modes (for example, may apply to the total BWs described herein and any additional BWs not explicitly discussed herein).

### EHT LTF Sequence Design

For 160 MHz and below total BWs (including 80+80 MHz), legacy 1×, 2×, and 4× symbol duration LTF tone plan sequences may be used for EHT LTF sequences. For example, the LTF sequences for 20 MHz are shown below (using 4× numerology). The LTF sequences other BWs and symbol durations are omitted for brevity.
1× LTF sequence in 20 MHz, where the tone index range is [−122: 122]
   HELTF_{-122,122}={0, 0, −1, 0, 0, 0, +1, 0, 0, 0, +1, 0, 0, 0, −1, 0, 0, 0, +1, 0, 0, 0, −1, 0, 0, 0, +1, 0, 0, 0, +1, 0, 0, 0, +1, 0, 0, 0, +1, 0, 0, 0, −1, 0, 0, 0, −1, 0, 0, 0, +1, 0, 0, 0, +1, 0, 0, 0, +1, 0, 0, 0, −1, 0, 0, 0, −1, 0, 0, 0, −1, 0, 0, 0, +1, 0, 0, 0, −1, 0, 0, 0, −1, 0, 0, 0, +1, 0, 0, 0, +1, 0, 0, 0, −1, 0, 0, 0, −1, 0, 0, 0, +1, 0, 0, 0, −1, 0, 0, 0, −1, 0, 0, 0, +1, 0, 0, 0, −1, 0, 0, 0, 0, 0, 0, 0, −1, 0, 0, 0, +1, 0, 0, 0, +1, 0, 0, 0, +1, 0, 0, 0, +1, 0, 0, 0, +1, 0, 0, 0, +1, 0, 0, 0, −1, 0, 0, 0, −1, 0, 0, 0, −1, 0, 0, 0, −1, 0, 0, 0, −1, 0, 0, 0, +1, 0, 0, 0, −1, 0, 0, 0, −1, 0, 0, 0, −1, 0, 0, 0, +1, 0, 0, 0, −1, 0, 0, 0, −1, 0, 0, 0, +1, 0, 0, 0, −1, 0, 0, 0, −1, 0, 0, 0, +1, 0, 0, 0, −1, 0, 0, 0, +1, 0, 0, 0, −1, 0, 0, 0, −1, 0, 0, 0, −1, 0, 0, 0, −1, 0, 0, 0, −1, 0, 0}
2×LTF sequence in 20 MHz, where the tone index range is [−122:122]
   HELTF_{-122,122}={−1, 0, −1, 0, −1, 0, +1, 0, +1, 0, −1, 0, +1, 0, −1, 0, −1, 0, −1, 0, −1, 0, +1, 0, −1, 0, +1, 0, −1, 0, −1, 0, +1, 0, +1, 0, −1, 0, +1, 0, +1, 0, +1, 0, +1, 0, +1, 0, −1, 0, +1, 0, −1, 0, +1, 0, −1, 0, −1, 0, +1, 0, +1, 0, −1, 0, +1, 0, −1, 0, −1, 0, −1, 0, −1, 0,+1, 0, −1, 0,+1, 0,+1, 0, +1, 0, −1, 0, −1, 0, +1, 0, −1, 0, −1, 0, −1, 0, −1, 0, −1, 0, +1, 0, −1, 0, −1, 0, −1, 0, +1, 0, +1, 0, +1, 0, −1, 0, −1, 0, +1, 0, 0, 0, +1, 0, −1, 0, +1, 0, +1, 0, −1, 0, +1, 0, +1, 0, −1, 0, +1, 0, +1, 0, −1, 0, −1, 0, +1, 0, −1, 0, +1, 0, +1, 0, +1, 0, +1, 0, −1, 0, +1, 0, −1, 0, +1, 0, +1, 0, −1, 0, −1, 0, +1, 0, −1, 0, −1, 0, −1, 0, −1, 0, −1, 0, +1, 0, −1, 0, +1, 0, +1, 0, −1, 0, −1, 0, +1, 0, +1, 0, −1, 0, +1, 0, −1, 0, −1, 0, −1, 0, −1, 0, +1, 0, −1, 0, +1, 0, +1, 0, +1, 0, −1, 0, −1,0, +1, 0, −1, 0, −1, 0, −1, 0, −1, 0, −1, 0, +1, 0, −1, 0, +1}
4×LTF sequence in 20 MHz, where the tone index range is [−122:122]
   HELTF_{-122,122}={−1, −1, +1, −1, +1, −1, +1, +1, +1, −1, +1, +1, +1, −1, −1, +1, −1, −1, −1, −1, −1, +1, +1, −1, −1, −1, −1, +1, +1, −1, +1, −1, +1, +1, +1, +1, −1, +1, −1, −1, +1, +1, −1, +1, +1, +1, +1, −1, −1, +1, −1, −1, −1, +1, +1, +1, +1, −1, +1, +1, −1, −1, −1, −1, +1, −1, −1, +1, +1, −1, +1, −1, −1, −1, −1, +1, −1, +1, −1, −1, −1, −1, −1, −1, +1, +1, −1, −1, −1, −1, −1, +1, −1, −1, +1, +1, +1, −1, +1, +1, +1, −1, +1, −1, +1, −1, −1, −1, −1, −1, +1, +1, +1, −1, −1, −1, +1, −1, +1, +1, +1, 0, 0, 0, −1, +1, −1, +1, −1, +1, +1, −1, +1, +1, +1, −1, −1, +1, −1, −1, +1, −1, +1, −1, +1, +1, +1, −1, +1, +1, +1, −1, −1, +1, −1, −1, −1, −1, −1, +1, +1, −1, −1, −1, −1, −1, −1, +1, −1, +1, −1, −1, −1, −1, +1, −1, +1, +1, −1, −1, +1, −1, −1, −1, −1, +1, +1, −1, +1, +1, +1, +1, +1, +1, +1, −1, +1, +1, −1, −1, −1, −1, +1, −1, −1, +1, +1, −1, +1, −1, −1, −1, −1, +1, −1, +1, −1, −1, +1, +1, +1, +1, −1, −1, +1, +1, +1, +1, +1, −1, +1, +1, −1, −1, −1, +1, −1, −1, −1, +1, −1, +1, −1, +1, +1}

In some implementations, for the 160 MHz mode and the 80+80 MHz mode in total 160 MHz BW, the concatenated LTF sequence across segments may be denoted as [LTF_0, LTF_1], where LTF_i is the LTF sequence for the i-th lowest 80 MHz subchannel. In some implementations, the concatenated LTF sequences for both the 160 MHz and the 80+80 MHz modes in total 160 MHz BW are the same, where they are duplicates of two legacy 80 MHz LTF sequences of same symbol duration, without phase rotation in any subchannel.

In some implementations, for the higher BWs, such as 240 MHz and 320 MHz, the LTF sequences may depend on 4× or 2× symbol duration tone plan designs. For example, for modes in the 240 total BW, the concatenated LTF sequence with a certain symbol duration across segments may be denoted as [LTF_0, LTF_1, LTF_2], where LTF i is the LTF sequence for the i-th lowest 80 MHz subchannel. For example, in some implementations, for modes in a total 320 MHz BW, the concatenated LTF sequence with a certain symbol duration across segments may be denoted as [LTF_0, LTF_1, LTF_2, LTF_3], where LTF_i is the LTF sequence for the i-th lowest 80 MHz subchannel. In some implementations, in an Option 1, each subchannel (or segment) may use the LTF sequences for that subchannel BW, depending on BW mode. Accordingly, HE-LTFs in 80 MHz may be used in each 80 MHz subchannel. In some implementations, in an Option 2, regardless of the BW mode, and for a given total BW, the concatenated LTF sequences may be used for all BW modes.

### EHT LTF Tones Design With 2× Tone Plans

The STF tone plan for 2× symbol duration may be designed such that each 26-tone RU has 1-2 STF tones in a non-trigger based (TB) HE-STF and 3-4 STF tones in a TB HE-STF. Further details are provided in FIGS. 10-12.

In EHT 80 and 160 MHz channels that is based on 2× symbol duration tone plans, since each data tone plan is based on HE40 and HE80 tone plans upclocked by 2, each 26-tone RU spans a wider range of tones (for example, 26×2−1=51 tones in a 4× symbol duration tone plan). Thus, non-TB HE STFs and TB HE-STFs provide appropriate coverage of tones in the 2× symbol duration tone plans as compared to the 4× symbol duration tone plans. Thus, EHT 80 and 160 MHz subchannels may use same STF tone designs for HE-STFs in corresponding BWs. The EHT 320 MHz channel may use the same STF tone designs for 80 MHz HE-STFs in each of the 80 MHz subchannels for the EHT 320 MHz channel.

### EHT LTF Tones Design With EHT 4× Tone Plans

In some implementations, EHT 4× symbol duration tone plans may use HE80 tone plans in each 80 MHz subchannel. In some implementations, in Option 1, HE-LTFs in 80 MHz are used in each EHT 80 MHz subchannel. In some implementations, in Option 2, HE-LTFs in 80 MHz are used in each EHT 80M Hz subchannel, subject to a sign flip or phase rotation in one or more subchannels. In some implementations, for the sign flip or phase rotation design in the concatenated LTF sequences, certain phase rotations (for example, +1, +j, −1, −j representing 0, 90, 180, 270 degree phase rotations, respectively) may be applied to a basic LTF sequence in one or more subchannels to minimize or reduce the peak-to-average-power ratio (PAPR) of the LTF signal. In some implementations, the PAPR could be evaluated in the contiguous 240 and 320 MHz BW modes. In some implementations, for the phase rotation coefficients, one coefficient is used for each subchannel, where each subchannel may be a 40 or 80 MHz subchannel unit. In some implementations, the phase rotation coefficients in LTF sequences for different symbol durations may not be the same. In some implementations, the phase rotation coefficients in the total 160 MHz BW may not be part of those in the total 240 and 320 MHz BWs. In some implementations, the phase rotation coefficients in the total 240 MHz BW may not be part of those in the total 320 MHz BW. In some implementations, in an Option 0, no phase rotation is used in the LTF sequence, therefore making all phase rotation coefficients equal to 1. In some implementations, other options of phase rotation coefficients are possible.

### EHT LTF Tones Design With EHT 2× Tone Plans

In some implementations, 2× symbol duration tone plans are used. In some implementations, in an Option A for LTF design for the EHT 2× symbol duration tone plan, HE40 tone plans upclocked by 2 are used for EHT 80 MHz channels and HE80 and RE160 tone plans upclocked by 2 are used for EHT 160 and 320 MHz channels. In some implementations, the 240 MHz channel uses [HE40 HE80] tone plans upclocked by 2 (when treated as 80+160 MHz) or [HE80 HE40] tone plans upclocked by 2 (when treated as 160+80 MHz) or [HE40 HE40 HE40] tone plans upclocked by 2 (when treated as 3×80 MHz). In some implementations, in an Option b, HE HE40 tone plans upclocked by 2 are used for an EHT 80 MHz channel. In some implementations, the EHT 80 MHz subchannel is duplicated two, three and four times for EHT 160, 240, and 320 MHz channels, respectively.

In some implementations, 1× and 2× symbol duration LTFs may be derived from 2× and 4× HE-LTFs upclocked by 2, respectively. In some implementations, the 2× and 4× HE-LTFs 40 MHz tone plans upclocked by 2 may be used as lx and 2× EHT-LTFs for an 80 MHz channel, respectively. In some implementations, for the lx and 2× EHT-LTFs for 160 and 320 MHz channels, according to the Option a described herein, the 2× and 4× HE-LTFs 80 and 160 MHz upclocked by 2 are used. In some implementations, for the lx and 2× EHT-LTFs for 160 and 320 MHz channels, according to the Option b described herein, the 2× and 4× HE-LTFs 40 MHz upclocked by 2 are duplicated two or four times. Table 1 shows a comparison of Type-I (1× and 2× symbol duration HE-LTFs) and Type-II (1× and 2× symbol duration LTFs based on 2× and 4× HE-LTFs upclocked by 2) LTFs for various conditions or capabilities.

TABLE 1

| | | Type-II (new 1x/2x LTFs |
|---|---|---|
| | | derived from 2x/4x HE-LTFs |
| | Type-I (1x/2x HE-LTFs) | upclocked by 2) |
| Tone range | Wider | Narrower |
| 11ax sounding support | Good for 11ax sounding | Lack of some tones for 11ax |
| | | sounding |
| EHT sounding support | Good for EHT sounding in | Good for EHT sounding |
| | 80 MHz; lack of some tones | |
| | for EHT sounding in | |
| | 160 MHz | |
| Pilot tone alignment | Pilot tones not aligned with | Pilot tones aligned with those |
| | those in data tone plan. But | in data tone plan |
| | per-user phase tracking could | |
| | still be done | |
| Duplication rule | 160 MHz LTF is duplicate of | No duplication |
| | two 80 MHz LTFs subject to | |
| | sign flips in some | |
| | subchannels | |

Table 2 shows LTF tone comparisons for the Type-I and Type-II LTFs for various subchannels. As noted, in some implementations, for the 80 MHz subchannel, the Type-I LTF may cover all populated tones in the Type-II LTF. As noted, in some implementations, for the 160 MHz subchannel, the Type-I and Type-II LTFs may not cover all populated tones of each other.

TABLE 2

| Channel | Type-I | Populated tones in | 11ax | | Populated tones in |
|---|---|---|---|---|---|
| BW | (HE- | Type-I in 4x | Feedback | Type-II | Type-II in 4x |
| (MHz) | LTF) | numerology | tones | (New LTF) | numerology |
| 40 | 2x HE- | [−244:2:−4, 4:2:244] | | | |
| | LTF | (242 tones) | | | |
| | 4x HE- | [−244:−3, 3:244] | | | |
| | LTF | (484 tones) | | | |
| 80 | 1x HE- | [−500:4:−4, 4:4:500] | [−500:Ng:−4, 4:Ng:500], | 2x HE-LTF | [−488:4:−8, 8:4:488] |
| | LTF | (250 tones) | Ng = 4 or 16 | in 40 MHz | (242 tones) → not cover |
| | | | | upclocked by | [±4, ±492, ±496, ±500] |
| | | | | 2 | |
| | 2x HE- | [−500:2:−4, 4:2:500] | | 4x HE-LTF | [−488:2:−6, 6:2:488] |
| | LTF | (498 tones) | | in 40 MHz | (484 tones) → not cover |
| | | | | upclocked by | [±4, ±490, ±492, ±494, |
| | | | | 2 | ±496, ±498, ±500] |
| | 4x HE- | [−500:−3, 3:500] | | | |
| | LTF | (996 tones) | | | |
| 160 | 1x HE- | [−1012:4:−516, −508:4:−12, | [−1012:Ng:−516, −508:Ng:−12, | 2x HE-LTF | [−1000:4:−8, 8:4:1000] |
| | LTF | 12:4:508, 516:4:1012] | 12:Ng:508, 516:Ng:1012], | in 80 MHz | (498 tones) → not cover |
| | | (500 tones) → not cover | Ng = 4 or 16 | upclocked by | [±1004, ±1008, ±1012] |
| | | [±8, ±512] | | 2 | |
| | 2x HE- | [−1012:2:−516, −508:2:−12, | | 4x HE-LTF | [−1000:2:−6, 6:2:1000] |
| | LTF | 12:2:508, 516:2:1012] | | in 80 MHz | (996 tones) → not cover |
| | | (996 tones) → not cover | | upclocked by | [±1002, ±1004, ±1006, |
| | | [±6, ±8, ±10, ±510, | | 2 | ±1008, ±1010, ±1012] |
| | | ±512, ±514] | | | |

### Option B Tone Plan

As described herein, the 1× and 2× HE-LTFs for 80 MHz subchannels could cover all populated tones in the 2× and 4× HE-LTFs in 40 MHz subchannels upclocked by 2. In some implementations, in the Option b tone plan, the 160, 240, and 320 MHz tone plans are based on duplication of the 80 MHz tone plan (for example, the HE40 upclocked by 2).

In some implementations, for Option 1, for 80 and 160 MHz subchannels, the lx and 2× legacy HE-LTFs may be used in the corresponding EHT channel BW. In some implementations, for 240 and 320 MHz channels, the three or four HE-LTFs in 80 MHz may be duplicated subject to a sign flip or phase rotation in one or more subchannels. In some implementations, for Option 2, for total 240 and 320 MHz BWs, three or four HE-LTFs in 80 MHz are duplicated subject to a sign flip or phase rotation in one or more subchannels. In some implementations, LTF designs according to the Options 1 and 2 also may apply the Options described above in relation to EHT 4× tone plans. In some implementations, the designed LTFs in 80 and 160 MHz are useful for communication null data packets (NDPs) for both legacy sounding and EHT sounding.

### Option A Tone Plan

In some implementations, an Option 1 may use lx and 2× HE LTFs for 80 MHz subchannels and may provide two options for 160 MHz subchannels. In a first Option 1a, HE PPDUs may use HE-LTFs while EHT PPDUs may use LTFs derived from the HE-LTFs upclocked by 2. In a second Option 1b, 1× and 2× LTFs may cover all legacy and EHT tones. In some implementations, for the 320 MHz channel, 2 LTFs in 160 MHz subchannels are duplicated subject to a sign flip or phase rotation in one or more subchannels. In some implementations, in an Option 2, the 160 MHz subchannel may be treated as described in Option 1a above. In some implementations, for the 320 MHz channel, the 320 MHz concatenated LTF sequence is generated by duplicating two LTFs in 160 MHz subject to a sign flip or phase rotation in one or more subchannels.
Table 3 includes LTF design according to the options described herein for particular subchannel BWs, indicating which tones are populated in the described options in 4× symbol duration numerology.

TABLE 3

| | | | | | Populated |
|---|---|---|---|---|---|
| Channel or | | | Populated tones | | tones in option |
| Subchannel | | LTF Design | in option 1 in 4x | LTF Design | 2 in 4x |
| BW (MHz) | | Option 1 | numerology | Option 2 | numerology |
| 80 | 1x LTF | 1x HE-LTF | [−500:4:−4, | | |
| | | | 4:4:500] | | |
| | | | (250 tones) | | |
| | 2x LTF | 2x HE-LTF | [−500:2:−4, | | |
| | | | 4:2:500] | | |
| | | | (498 tones) | | |
| 160 | 1x LTF | 2x HE-LTF in | A1 = [−1012:4:−516, −508:4:−12, | New 1x LTF to | A2= [−1012:4:−8, 8:4:1012] |
| | | 80 MHz | 12:4:508, | cover | (504 tones) |
| | | upclocked by | 516:4:1012] | 11ax/EHT | |
| | | 2 | (500 tones) | | |
| | 2x LTF | 4x HE-LTF in | B1 = [−1012:2:−516, −508:2:−12, | New 2x LTF | B2 = [−1012:2:−6, 6:2:1012] |
| | | 80 MHz | 12:2:508, | to cover | (1008 tones) |
| | | upclocked by | 516:2:1012] | 11ax/EHT | |
| | | 2 | (996 tones) | | |
| 320 | 1x LTF | Duplicate of | [A1 − 1024, | Duplicate of | [A2 − 1024, |
| | | two option 1 | A1 + 1024] | two option 2 of | A2 + 1024] |
| | | of 160 MHz | (1000 tones) | 160 MHz | (1008 tones) |
| | 2x LTF | Duplicate of | [B1 − 1024, | Duplicate of | [B2 − 1024, |
| | | two option 1 | B1 + 1024] | two option 2 of | B2 + 1024] |
| | | of 160 MHz | (1992 tones) | 160 MHz | (2016 tones) |

In some implementations, the 160 MHz Option 2 may use lx and 2× LTFs to cover all legacy and EHT tones. In some implementations, due to compatibility to legacy STAs, values in existing tones in the legacy 160 MHz HE-LTF sequence remain unchanged. In some implementations, the following 16 missing tones in the legacy 160 MHz HE-LTF sequence may need to be filled: 4 tones in 1× LTF: [±8, ±512] and 12 tones in 2× LTF: [±6, ±8, ±10, ±510, ±512, ±514]. In some implementations, the same LTF tone may have different values for LTF sequence of different symbol durations. In some implementations, the values for the missing tones may be determined based on: minimizing the PAPR of the LTF signal; +1 or −1 for each missing tone based on those values being the only nonzero values in existing LTF sequences (to maintain legacy compatibility); a phase rotation coefficient (such as +1, +j, −1, −j) may be applied to each missing tone to further minimize PAPR; and selected from one of +1, +j, −1, and H. In an Option Oa, in some implementations, the same value is used for all 16 missing tones, and this value could be any of +1, +j, −1, or −j. In an Option 0b, in some implementations, the same value is selected for the 8 positive indexed tones and the same value with sign flip is selected for the 8 negative indexed tones, where the values are selected from +1, +j, −1, or j. In an Option 0c, in some implementations, the same value is selected for tones with the same absolute index (for example, indices +8 and −8). In some implementations, other options are possible.

In some implementations, the 240 MHz Option 2 may use, for Option a, [HE40 HE80] tone plans upclocked by 2 (when treated as 80+160 MHz) or [HE80 HE40] tone plans upclocked by 2 (when treated as 160+80 MHz) or [HE40 HE40 HE40] tone plans upclocked by 2 (when treated as 3×80 MHz). Therefore, in some implementationsof LTF design, each 80 MHz subchannel uses the lx and 2× HE-LTFs, and each 160 MHz subchannel uses the lx and 2× LTFs for 160 MHz (Option 2), subject to a sign flips or phase rotations in one or more subchannels. In some implementations, the 320 MHz Option 2 may duplicate 2 LTFs in 160 MHz (Option 2) subject to a sign flip or phase rotation in one or more subchannels, where the LTFs are the Option 2 160 MHz LTFs.

In some implementations, the sign flips or phase rotations applied are determined based on certain phase rotations, for example +1, +j, −1, −j representing 0, 90, 180, 270 degree phase rotation, respectively, applying to a basic LTF sequence in one or more subchannels to minimize the PAPR of the LTF signal. In some implementations, the sign flips or phase rotations applied are determined based on evaluating such PAPR in the contiguous 240 and 320 MHz BW mode. In some implementations, the sign flips or phase rotations applied are determined based on the LTF signal being generated based on different MIMO setups (such as, single-in, single-out (SISO), 4Tx by 4Rx by 4ss, or the like) with single stream pilots (SSP). In some implementations, the phase rotation coefficients are determined according to the following: one coefficient is used for a subchannel, for example, 40 MHz, 80 MHz, and so forth; the phase rotation coefficients in the total 240 MHz BW may not be part of those in the total 320 MHz BW; no phase rotation, for example, phase rotation coefficients are all 1; or other options are possible.

The examples in this disclosure are provided to aid the reader in understanding. However, in other implementations, information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

### Implementing Technology

As mentioned previously, information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and features disclosed herein. The word “example” is used exclusively herein to mean “serving as an example, instance, or illustration.” Any implementation described herein as “example” should not to be construed as the sole, preferred or advantageous implementation over other implementations.

Certain features that can be described in this specification in the context of separate implementations also can be implemented in combination in a single implementation. Conversely, various features that can be described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above can be performed by any suitable means capable of performing the operations, including any combination of hardware, software, circuits, or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor also can be implemented as a combination of computing devices, for example, a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave can be included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can include non-transitory computer readable medium (for example, tangible media). In addition, in some aspects computer readable medium can include transitory computer readable medium (for example, a signal). Combinations of the above are included within the scope of computer-readable media.

The methods disclosed herein may include one or more steps or actions for achieving the described method. The method steps or actions can be interchanged with one another without departing from the scope of the claims. In other words, unless a specific order of steps or actions is specified, the order or use of specific steps or actions can be modified without departing from the scope of the claims.

Further, in some implementations, modules or other appropriate means for performing the methods and techniques described herein can be downloaded or otherwise obtained by a user terminal or base station as applicable. For example, such a device can be coupled to a server to facilitate the transfer of means for performing the methods described herein. Alternatively, various methods described herein can be provided via storage means (for example, RAM, ROM, a physical storage medium such as a compact disc (CD) or floppy disk, or the like), such that a user terminal or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. An apparatus for wireless communication, comprising:
a processing system configured to:
generate a message for transmission via a wireless network using a first channel having one of a 240 MHz or 320 MHz total channel bandwidth, and
generate a long training field (LTF) for the message, wherein the LTF includes a sequence based, at least in part, on the 240 MHz or 320 MHz total channel bandwidth for the first channel; and
an interface configured to output the message for transmission via the wireless network.

2. The apparatus of claim 1, wherein the LTF is formed from a concatenated sequence of sub-LTFs that are defined for smaller bandwidth channels than the 240 or 320 MHz total channel bandwidth.

3. The apparatus of claim 2, wherein the processing system is configured to apply a phase rotation to at least one of the sub-LTFs of the concatenated sequence.

4. The apparatus of claim 1, wherein the processing system is configured to prepare the LTF by upclocking a sub-LTF defined for a smaller bandwidth channel.

5. The apparatus of claim 4, wherein the processing system is configured to add sequence values for missing tones in a tone plan for the 240 MHz or 320 MHz total channel bandwidth, the missing tones remaining after upclocking the sub-LTF.

6. The apparatus of claim 5, wherein the processing system is configured to apply a phase rotation to at least some of the sequence values.

7. The apparatus of claim 6, wherein the phase rotation is configured to reduce a peak-to-average-power ratio (PAPR) of the message as compared to a non-phase rotated LTF.

8. The apparatus of claim 1, wherein the LTF is formed from a concatenated sequence of sub-LTFs for an 80 MHz bandwidth channel.

9. The apparatus of claim 8, wherein the processing system is configured to apply a phase rotation to at least some of the sub-LTFs.

10. An method for wireless communication, comprising:
generating a message for transmission via a wireless network using a first channel having one of a 240 MHz or 320 MHz total channel bandwidth;
generating a long training field (LTF) for the message, wherein the LTF includes a sequence based, at least in part, on the 240 MHz or 320 MHz total channel bandwidth for the first channel; and
outputting, via an interface, the message for transmission via the wireless network.

11. The method of claim 10, wherein the LTF is formed from a concatenated sequence of sub-LTFs that are defined for smaller bandwidth channels than the 240 or 320 MHz total channel bandwidth.

12. The method of claim 11, further comprising applying a phase rotation to at least one of the sub-LTFs of the concatenated sequence.

13. The method of claim 10, further comprising preparing the LTF by upclocking a sub-LTF defined for a smaller bandwidth channel.

14. The method of claim 13, further comprising adding sequence values for missing tones in a tone plan for the 240 MHz or 320 MHz total channel bandwidth, the missing tones remaining after upclocking the sub-LTF.

15. The method of claim 14, further comprising applying a phase rotation to at least some of the sequence values.

16. The method of claim 15, wherein the phase rotation is configured to reduce a peak-to-average-power ratio (PAPR) of the message as compared to a non-phase rotated LTF.

17. The method of claim 10, wherein the LTF is formed from a concatenated sequence of sub-LTFs for an 80 MHz bandwidth channel.

18. The method of claim 17, further comprising applying a phase rotation to at least some of the sub-LTFs.

19. A wireless communication device, comprising:
a housing;
an antenna attached to the housing and electrically coupled to a transceiver;
the transceiver for communicating with a wireless network using a first channel having one of a 240 MHz or 320 MHz total channel bandwidth; and
a processing system configured to:
generate a message for transmission via the transceiver;
generate a long training field (LTF) for the message, wherein the LTF includes a training sequence based, at least in part, on the 240 MHz or 320 MHz total channel bandwidth for the first channel; and
output the message via the transceiver.
